(19) United States
(12) Patent Application Publication
(10) Pub. No.: US 2026/0095848 A1
(43) Pub. Date: Apr. 2, 2026

(54) NETWORK MOVE SYSTEMS AND METHODS

(71) Applicant: DISH Wireless L.L.C., Englewood, CO (US)

(72) Inventor: Jeffrey Wendeborn, Englewood, CO (US)

(21) Appl. No.: 18/902,230

(22) Filed: Sep. 30, 2024

(51) Int. Cl. H04W 48/18; H04W 8/02

(52) U.S. Cl. CPC H04W 48/18; H04W 8/02

(57) ABSTRACT

A disclosed method may include receiving, at a mobile virtual network operator, an indication for a mobile virtual network operator to perform a network switch, and performing, by the mobile virtual network operator in response to receiving the indication, the network switch, wherein electronic communication between the mobile virtual network operator and the client device of the client configuring the client device for the network switch is performed entirely through cellular connectivity between the mobile virtual network operator and the client device over-the-air.

### BRIEF SUMMARY

This disclosure is generally directed to systems, methods, and computer-readable media relating to network move applications in the context of mobile virtual network operators. Generally speaking, mobile virtual network operators can lease usage of cellular telecommunication infrastructure to provide telecommunication service to clients of the mobile virtual network operators. As used herein, the term “mobile virtual network operator” can broadly refer to both pure mobile virtual network operators that do not maintain their own infrastructure and also hybrid or other mobile virtual network operators that can lease usage of cellular telecommunication infrastructure for at least some of their clients while also maintaining their own cellular telecommunication for at least some other ones of the clients, as discussed in more detail below.

Mobile virtual network operators can encounter a multitude of challenges in their efforts to provide seamless and efficient telecommunication services to their diverse clientele. One of the most significant obstacles they face can be the inherent complexity associated with network switching processes (as used herein the terms “network switch” and “network move” can be interchangeable). The related methodologies employed for transitioning a client's home network from one mobile network operator to another can often involve intricate and cumbersome procedures. These related approaches can potentially result in a range of undesirable outcomes, including but not limited to temporary service interruptions, considerable inconvenience for the end-users, and suboptimal utilization of valuable network resources. A notable limitation of many related processes is their reliance on Wi-Fi connections for executing certain helpful steps in the network switching procedure. This dependence on Wi-Fi can introduce additional complications, as Wi-Fi connectivity may not always be readily available or may present security vulnerabilities in certain environments. The cumulative effect of these various factors can significantly impede the ability of mobile virtual network operators to deliver the level of service quality and flexibility that their clients increasingly demand in today's rapidly evolving telecommunications landscape.

The present disclosure aims to address these multifaceted challenges by introducing a suite of innovative methods and systems designed to implement network moves with enhanced efficiency and minimal disruption to service continuity. An aspect of this approach can be a streamlined network switching process that is executed entirely over cellular networks, thereby eliminating the need for Wi-Fi connectivity at any stage of the procedure. This novel methodology can offer several potential advantages, including a substantial reduction in the overall complexity of network switches and an enhancement in the security of the process through the exclusive use of cellular connections. These optimizations can potentially yield a range of benefits, such as accelerated switch times, a reduction in the overall network load, and improvements in system performance across various metrics. Furthermore, the disclosure can introduce a set of automated, user-centric network switching processes that can minimize or potentially eliminate the need for manual intervention on the part of the client. By addressing these various aspects of the network switching process, the methods and systems presented in this disclosure can enable mobile virtual network operators to offer more responsive, reliable, and user-friendly services to their clients, potentially strengthening their competitive position in the telecommunications market. Additionally, these innovations can pave the way for more efficient handling of large-scale network transitions, allowing mobile virtual network operators to manage their resources more effectively and adapt to changing market conditions with greater agility.

The maintenance of uninterrupted service continuity during network transitions can be a matter of importance for mobile virtual network operators and the diverse array of clients they serve. The related methods employed for network switching can often result in temporary lapses in service as client devices disconnect from one network and establish connections with another. These service interruptions, even if brief, can have significant repercussions across various use cases and industries. For instance, business users relying on constant connectivity for time-sensitive operations may experience disruptions in their workflows. Emergency services, which depend on reliable communication channels to coordinate rapid responses, may face potential delays or communication breakdowns during certain moments. Similarly, the burgeoning field of Internet of Things devices, which often require persistent connectivity to function effectively and transmit data in real-time, may experience disruptions that could compromise their intended functions. More generally, any service interruption can be inconvenient or annoying to the end-user. To address these concerns, the present disclosure introduces a range of innovative techniques designed to maintain seamless service continuity throughout the entirety of the network switching process. These advanced methods can include sophisticated mechanisms for coordinating the timing of various steps in the switching process. One such approach can involve strategically delaying the port in procedure until after services have been fully provisioned on the target network, which can help ensure that the client device always has an active connection to fall back on during the transition. Additionally, the disclosure presents a port out interception technique that can empower mobile virtual network operators to precisely coordinate the timing of service disconnection from the original network and activation on the new network. This novel approach can significantly mitigate or potentially eliminate service interruptions during network switches, thereby enhancing the overall client experience and ensuring the maintenance of connections across a wide range of use scenarios. By implementing these advanced continuity-preserving techniques, mobile virtual network operators can potentially differentiate themselves in a competitive market by offering more reliable and seamless services to their clients.

The efficient management of multiple network profiles on a single subscriber identity module can be helpful for mobile virtual network operators seeking to offer flexible and responsive services. The disclosure can provide advanced methods for handling multiple profiles, including techniques for downloading, activating, and switching between profiles without requiring physical subscriber identity module card replacements. This capability can enable mobile virtual network operators to offer more flexible service options and respond quickly to changing network conditions or client needs. Furthermore, the disclosure can present methods for efficiently pre-loading multiple profiles onto a single subscriber identity module, allowing for rapid switching between networks when needed. This pre-allocation can reduce the time and resources required for network switches and can enhance the flexibility of mobile virtual network operator service offerings. The improvement of subscriber identity module card memory usage through intelligent profile management can also be addressed, allowing for more efficient use of limited storage space on these devices. These advancements in profile management can potentially enable mobile virtual network operators to support a wider range of network partnerships and service configurations, thereby expanding their market reach and enhancing their ability to meet diverse client needs. Additionally, the ability to remotely manage and update profiles can significantly reduce the operational costs associated with physical subscriber identity module card replacements and manual reconfigurations, leading to improved operational efficiency for the mobile virtual network operator.

Network switch failures can occur due to various factors, including connectivity issues, device incompatibilities, or system errors. The present disclosure can introduce robust mechanisms for detecting, diagnosing, and responding to switch failures. These mechanisms can include real-time auditing of switch attempts, automated fallback procedures, and intelligent remediation processes to minimize the impact of failures on client services. The disclosure can provide detailed methods for performing comprehensive audits of attempted network switches, allowing mobile virtual network operators to quickly identify the root causes of failures and take appropriate corrective actions. Additionally, the disclosure can present strategies for gracefully handling failed switches, including methods for reverting to the original network configuration when necessary to maintain service continuity for the client. These failure handling mechanisms can significantly improve the reliability and resilience of network switching processes, enhancing the overall quality of service provided by mobile virtual network operators. Furthermore, the implementation of machine learning algorithms to analyze patterns in switch failures over time can enable mobile virtual network operators to proactively identify and address potential issues before they impact customers, leading to continuous improvement in the reliability of network switching processes.

The present disclosure can also introduce methods for dynamically responding to changing network conditions, allowing mobile virtual network operators to optimize their clients'connectivity in real-time. This can include techniques for monitoring network performance across multiple mobile network operators, automatically initiating network switches when predefined thresholds are met, and load balancing across available networks to ensure optimal performance and cost-efficiency. These dynamic response capabilities can be particularly valuable in scenarios where network conditions are highly variable, such as in urban areas with congested networks or rural areas with limited coverage. By enabling mobile virtual network operators to proactively manage network connections, the disclosure can help ensure that clients consistently receive the best possible service quality and value. Furthermore, these dynamic optimization techniques can be extended to incorporate predictive analytics, leveraging historical data and machine learning algorithms to anticipate network congestion or outages and preemptively switch clients to alternative networks, thereby maintaining a consistently high quality of service.

The disclosure can also address the challenges associated with scaling network switching processes to accommodate large numbers of clients simultaneously. This can involve detailing methods for efficient batch processing of network switches, load distribution across multiple switching servers, and the implementation of queue management systems to handle high volumes of switch requests during peak periods. These scalability enhancements can enable mobile virtual network operators to perform large-scale network transitions, such as when migrating entire customer segments between partner networks or when responding to widespread network outages, without overwhelming their systems or compromising service quality.

In a first embodiment, a method can include: (i) receiving, at a mobile virtual network operator, an indication for a mobile virtual network operator to perform a network switch by switching a home network of a client device of a client of the mobile virtual network operator from a source network infrastructure of a source mobile network operator that is serving the client for the mobile virtual network operator to a target network infrastructure of a target mobile network operator that is serving clients for the mobile virtual network operator and (ii) performing, by the mobile virtual network operator in response to receiving the indication, the network switch by switching the home network of the client device of the client of the mobile virtual network operator from the source network infrastructure of the source mobile network operator that is serving the client for the mobile virtual network operator to the target network infrastructure of the target mobile network operator that is serving clients for the mobile virtual network operator. In some examples, electronic communication between the mobile virtual network operator and the client device of the client configuring the client device for the network switch is performed entirely through cellular connectivity between the mobile virtual network operator and the client device over-the-air.

In examples of the first embodiment, the source mobile network operator can comprise the mobile virtual network operator functioning as a mobile network operator and the target mobile network operator can comprise a third-party mobile network operator.

In examples of the first embodiment, performing the network switch can comprise the mobile virtual network operator downloading and activating an electronic subscriber identity module profile for the target mobile network operator on the client device while maintaining active connectivity between the client device and the source network infrastructure.

In examples of the first embodiment, performing the network switch can comprise the mobile virtual network operator switching an active subscriber identity module profile from a first profile specific to the source network infrastructure to a second profile specific to the target network infrastructure.

In examples of the first embodiment, the source mobile network operator can comprise a third-party mobile network operator and the target mobile network operator can comprise the mobile virtual network operator functioning as a mobile network operator.

In examples of the first embodiment, the mobile virtual network operator can perform the network switch entirely through cellular connectivity between the mobile virtual network operator and the client device over-the-air such that a Wi-Fi connection to the client device is bypassed.

In examples of the first embodiment, performing the network switch can comprise the mobile virtual network operator provisioning services for the client device on the target network infrastructure before initiating a port out process from the source network infrastructure.

In examples of the first embodiment, the source mobile network operator and the target mobile network operator can comprise different third-party mobile network operators that are both distinct from the mobile virtual network operator.

In examples of the first embodiment, performing the network switch can comprise the mobile virtual network operator coordinating timing of a port in process and activation of services on the target network infrastructure at least in part by delaying a port in process until only after confirming successful activation of services on the target network infrastructure.

In examples of the first embodiment, performing the network switch can comprise the mobile virtual network operator maintaining cellular connectivity with the client device on both the source network infrastructure and the target network infrastructure simultaneously during a portion of the network switch.

In examples of the first embodiment, a non-transitory computer-readable medium has instructions stored thereon that, when executed by at least one physical computing processor, cause a computing device to perform operations comprising: (i) receiving, at a mobile virtual network operator, an indication for a mobile virtual network operator to perform a network switch by switching a home network of a client device of a client of the mobile virtual network operator from a source network infrastructure of a source mobile network operator that is serving the client for the mobile virtual network operator to a target network infrastructure of a target mobile network operator that is serving clients for the mobile virtual network operator and (ii) performing, by the mobile virtual network operator in response to receiving the indication, the network switch by switching the home network of the client device of the client of the mobile virtual network operator from the source network infrastructure of the source mobile network operator that is serving the client for the mobile virtual network operator to the target network infrastructure of the target mobile network operator that is serving clients for the mobile virtual network operator. In some examples, electronic communication between the mobile virtual network operator and the client device of the client configuring the client device for the network switch is performed entirely through cellular connectivity between the mobile virtual network operator and the client device over-the-air.

In examples of the first embodiment, a system can comprise: (i) at least one physical computing processor of a computing device and (ii) a non-transitory computer-readable medium that has instructions stored thereon that, when executed by the at least one physical computing processor, cause the computing device to perform operations comprising: (i) receiving, at a mobile virtual network operator, an indication for a mobile virtual network operator to perform a network switch by switching a home network of a client device of a client of the mobile virtual network operator from a source network infrastructure of a source mobile network operator that is serving the client for the mobile virtual network operator to a target network infrastructure of a target mobile network operator that is serving clients for the mobile virtual network operator and (ii) performing, by the mobile virtual network operator in response to receiving the indication, the network switch by switching the home network of the client device of the client of the mobile virtual network operator from the source network infrastructure of the source mobile network operator that is serving the client for the mobile virtual network operator to the target network infrastructure of the target mobile network operator that is serving clients for the mobile virtual network operator. In some examples, electronic communication between the mobile virtual network operator and the client device of the client configuring the client device for the network switch is performed entirely through cellular connectivity between the mobile virtual network operator and the client device over-the-air.

In a second embodiment, a method can include: (i) receiving, at a mobile virtual network operator, an indication for a mobile virtual network operator to perform a network switch by switching a home network of a client device of a client of the mobile virtual network operator from a source network infrastructure of a source mobile network operator that is serving the client for the mobile virtual network operator to a target network infrastructure of a target mobile network operator that is serving clients for the mobile virtual network operator and (ii) performing, by the mobile virtual network operator in response to receiving the indication, the network switch by switching the home network of the client device of the client of the mobile virtual network operator from the source network infrastructure of the source mobile network operator that is serving the client for the mobile virtual network operator to the target network infrastructure of the target mobile network operator that is serving clients for the mobile virtual network operator. In some examples, the mobile virtual network operator also functions as the source mobile network operator and the mobile virtual network operator is configured to designedly delay the mobile virtual network operator disconnecting cellular connectivity between the source mobile network operator and the client device until after the mobile virtual network operator establishes cellular connectivity between the target mobile network operator and the client device.

In examples of the second embodiment, designedly delaying the mobile virtual network operator disconnecting of cellular connectivity can comprise implementing an interceptor process embedded into a local number portability platform of the mobile virtual network operator.

In examples of the second embodiment, designedly delaying the mobile virtual network operator disconnecting of cellular connectivity can comprise approving a port out request from the target mobile network operator and delaying an actual disconnect of the client device from the source mobile network operator.

In examples of the second embodiment, the mobile virtual network operator can maintain cellular connectivity with the client device on both the source mobile network operator and the target mobile network operator simultaneously during a portion of the network switch.

In examples of the second embodiment, designedly delaying the mobile virtual network operator disconnecting of cellular connectivity can allow the mobile virtual network operator to orchestrate the network switch without relying on Wi-Fi connectivity during the network switch.

In examples of the second embodiment, the method can further comprise activating a subscription for the client device on the target mobile network operator before initiating a port out process from the source mobile network operator.

In examples of the second embodiment, designedly delaying the mobile virtual network operator disconnecting of cellular connectivity can comprise: receiving a port out request from the target mobile network operator, validating the port out request, approving the port out request, and in response to receiving the port out request, triggering a predetermined delay of a disconnect of services on the source mobile network operator rather than immediately triggering the disconnect.

In examples of the second embodiment, the mobile virtual network operator can coordinate timing of a port out process and activation of services on the target mobile network operator.

In examples of the second embodiment, the method can further comprise downloading and activating an electronic subscriber identity module profile for the target mobile network operator on the client device while maintaining active connectivity between the source mobile network operator and the client device.

In examples of the second embodiment, designedly delaying the mobile virtual network operator disconnecting of cellular connectivity can comprise implementing an interceptor process embedded into a local number portability platform of the mobile virtual network operator.

In examples of the second embodiment, a non-transitory computer-readable medium can have instructions stored thereon that, when executed by at least one physical computing processor, cause a computing device to perform operations comprising: (i) receiving, at a mobile virtual network operator, an indication for a mobile virtual network operator to perform a network switch by switching a home network of a client device of a client of the mobile virtual network operator from a source network infrastructure of a source mobile network operator that is serving the client for the mobile virtual network operator to a target network infrastructure of a target mobile network operator that is serving clients for the mobile virtual network operator and (ii) performing, by the mobile virtual network operator in response to receiving the indication, the network switch by switching the home network of the client device of the client of the mobile virtual network operator from the source network infrastructure of the source mobile network operator that is serving the client for the mobile virtual network operator to the target network infrastructure of the target mobile network operator that is serving clients for the mobile virtual network operator. In some examples, the mobile virtual network operator also functions as the source mobile network operator and the mobile virtual network operator is configured to designedly delay the mobile virtual network operator disconnecting cellular connectivity between the source mobile network operator and the client device until after the mobile virtual network operator establishes cellular connectivity between the target mobile network operator and the client device.

In examples of the second embodiment, a system can comprise: (i) at least one physical computing processor of a computing device and (ii) a non-transitory computer-readable medium that has instructions stored thereon that, when executed by the at least one physical computing processor, cause the computing device to perform operations comprising: (i) receiving, at a mobile virtual network operator, an indication for a mobile virtual network operator to perform a network switch by switching a home network of a client device of a client of the mobile virtual network operator from a source network infrastructure of a source mobile network operator that is serving the client for the mobile virtual network operator to a target network infrastructure of a target mobile network operator that is serving clients for the mobile virtual network operator and (ii) performing, by the mobile virtual network operator in response to receiving the indication, the network switch by switching the home network of the client device of the client of the mobile virtual network operator from the source network infrastructure of the source mobile network operator that is serving the client for the mobile virtual network operator to the target network infrastructure of the target mobile network operator that is serving clients for the mobile virtual network operator. In some examples, the mobile virtual network operator also functions as the source mobile network operator and the mobile virtual network operator is configured to designedly delay the mobile virtual network operator disconnecting cellular connectivity between the source mobile network operator and the client device until after the mobile virtual network operator establishes cellular connectivity between the target mobile network operator and the client device.

In a third embodiment, a method can include: (i) performing, by a mobile virtual network operator in response to receiving an indication to perform a network switch, an attempted network switch by attempting to switch a home network of a client device of a client of the mobile virtual network operator from a source network infrastructure of a source mobile network operator that is serving the client for the mobile virtual network operator to a target network infrastructure of a target mobile network operator that is serving clients for the mobile virtual network operator, (ii) detecting, by the mobile virtual network operator after performing the attempted network switch, that the attempted network switch failed, (iii) performing, by the mobile virtual network operator in response to detecting that the attempted network switch failed, an audit of the attempted network switch, and (iv) performing, by the mobile virtual network operator in response to a negative result of the audit of the attempted network switch, a remedial action that remediates the negative result of the attempted network switch. In some examples, the remedial action can comprise successfully completing the attempted network switch or performing a reverse network switch back from the target network infrastructure of the target mobile network operator to the source network infrastructure of the source mobile network operator.

In examples of the third embodiment, detecting that the attempted network switch failed can comprise receiving an indeterminate response from a remote subscriber identity module provisioning platform regarding a state of a subscriber identity module of the client device.

In examples of the third embodiment, performing the audit of the attempted network switch can comprise: (i) attempting to reestablish connectivity with the client device, (ii) analyzing connection data, or (iii) examining call detail record data associated with the client device.

In examples of the third embodiment, the remedial action can comprise resynchronizing a remote subscriber identity module provisioning platform with a subscriber identity module of the client device to determine whether the subscriber identity module is using a profile of the source network infrastructure or a profile of the target network infrastructure.

In examples of the third embodiment, the method can further include: (i) detecting a definitive failure of the attempted network switch where a subscriber identity module of the client device reports remaining on the source network infrastructure and (ii) in response to detecting the definitive failure, aborting the network switch and maintaining the client device on the source network infrastructure.

In examples of the third embodiment, performing the remedial action can comprise: (i) detecting that a subscriber identity module profile switch was successful despite an initial indeterminate response and (ii) proceeding with completion of the network switch to the target network infrastructure.

In examples of the third embodiment, the method can further include implementing an automated fallout process to determine a state of a subscriber identity module of the client device when an initial profile switch attempt results in an indeterminate state.

In examples of the third embodiment, performing the audit of the attempted network switch can comprise: (i) verifying connectivity between a remote subscriber identity module provisioning platform and a subscriber identity module of the client device and (ii) analyzing a report from the subscriber identity module regarding its current state and installed profiles.

In examples of the third embodiment, the remedial action can comprise reverting the client device to the source network infrastructure.

In examples of the third embodiment, the method can further include maintaining, by the mobile virtual network operator, simultaneous connectivity with the client device on both the source network infrastructure and the target network infrastructure during a portion of the network switch.

In examples of the third embodiment, a non-transitory computer-readable medium can have instructions stored thereon that, when executed by at least one physical computing processor, cause a computing device to perform operations comprising: (i) performing, by a mobile virtual network operator in response to receiving an indication to perform a network switch, an attempted network switch by attempting to switch a home network of a client device of a client of the mobile virtual network operator from a source network infrastructure of a source mobile network operator that is serving the client for the mobile virtual network operator to a target network infrastructure of a target mobile network operator that is serving clients for the mobile virtual network operator, (ii) detecting, by the mobile virtual network operator after performing the attempted network switch, that the attempted network switch failed, (iii) performing, by the mobile virtual network operator in response to detecting that the attempted network switch failed, an audit of the attempted network switch, and (iv) performing, by the mobile virtual network operator in response to a negative result of the audit of the attempted network switch, a remedial action that remediates the negative result of the attempted network switch. In some examples, the remedial action can comprise successfully completing the attempted network switch or performing a reverse network switch back from the target network infrastructure of the target mobile network operator to the source network infrastructure of the source mobile network operator.

In examples of the third embodiment, a system can comprise: (i) at least one physical computing processor of a computing device and (ii) a non-transitory computer-readable medium that has instructions stored thereon that, when executed by the at least one physical computing processor, cause the computing device to perform operations comprising: (i) performing, by a mobile virtual network operator in response to receiving an indication to perform a network switch, an attempted network switch by attempting to switch a home network of a client device of a client of the mobile virtual network operator from a source network infrastructure of a source mobile network operator that is serving the client for the mobile virtual network operator to a target network infrastructure of a target mobile network operator that is serving clients for the mobile virtual network operator, (ii) detecting, by the mobile virtual network operator after performing the attempted network switch, that the attempted network switch failed, (iii) performing, by the mobile virtual network operator in response to detecting that the attempted network switch failed, an audit of the attempted network switch, and (iv) performing, by the mobile virtual network operator in response to a negative result of the audit of the attempted network switch, a remedial action that remediates the negative result of the attempted network switch. In some examples, the remedial action can comprise successfully completing the attempted network switch or performing a reverse network switch back from the target network infrastructure of the target mobile network operator to the source network infrastructure of the source mobile network operator.

In a fourth embodiment, a method can include: (i) establishing, by a mobile virtual network operator, a configuration such that the mobile virtual network operator provides telecommunication service to a first set of clients of the mobile virtual network operator through a first mobile network operator and simultaneously provides telecommunication service to a second set of clients of the mobile virtual network operator through a second mobile network operator that is distinct from the mobile virtual network operator, (ii) preloading, by the mobile virtual network operator, a subscriber identity module with a plurality of profiles comprising a first profile that specifically enables telecommunication through the first mobile network operator providing telecommunication service to the first set of clients of the mobile virtual network operator and a second profile that specifically enables telecommunication through the second mobile network operator providing telecommunication service to the second set of clients of the mobile virtual network operator, and (iii) providing, by the mobile virtual network operator after preloading the subscriber identity module, the subscriber identity module to a specific client of the mobile virtual network operator such that the mobile virtual network operator is enabled to remotely switch an active profile of the subscriber identity module between the first profile and the second profile.

In examples of the fourth embodiment, the first profile and the second profile can be encrypted using shared secrets specific to the first mobile network operator and the second mobile network operator, respectively.

In examples of the fourth embodiment, the method further comprises preloading a third profile that is specific to a third mobile network operator that is distinct from the first mobile network operator and the second mobile network operator onto the subscriber identity module.

In examples of the fourth embodiment, preloading the subscriber identity module with the plurality of profiles can be performed during manufacturing of the subscriber identity module.

In examples of the fourth embodiment, preloading the subscriber identity module with the plurality of profiles can be performed after manufacturing but before providing the subscriber identity module to the specific client.

In examples of the fourth embodiment, the method can further include: (i) detecting that switching the subscriber identity module to the second mobile network operator would result in improved telecommunication service or reduced resource consumption and (ii) remotely switching the subscriber identity module from the first profile to the second profile in response to the detecting.

In examples of the fourth embodiment, the mobile virtual network operator can be enabled to remotely switch the active profile of the subscriber identity module between the first profile and the second profile without client input.

In examples of the fourth embodiment, the first mobile network operator can also be distinct from the mobile virtual network operator.

In examples of the fourth embodiment, switching between the first profile and the second profile can be performed without interrupting telecommunication service to the specific client.

In examples of the fourth embodiment, electronic communication between the mobile virtual network operator and a client device of the client configuring the client device for the network switch can be performed entirely through cellular connectivity between the mobile virtual network operator and the client device over-the-air.

In examples of the fourth embodiment, a non-transitory computer-readable medium can have instructions stored thereon that, when executed by at least one physical computing processor, cause a computing device to perform operations comprising: (i) establishing, by a mobile virtual network operator, a configuration such that the mobile virtual network operator provides telecommunication service to a first set of clients of the mobile virtual network operator through a first mobile network operator and simultaneously provides telecommunication service to a second set of clients of the mobile virtual network operator through a second mobile network operator that is distinct from the mobile virtual network operator, (ii) preloading, by the mobile virtual network operator, a subscriber identity module with a plurality of profiles comprising a first profile that specifically enables telecommunication through the first mobile network operator providing telecommunication service to the first set of clients of the mobile virtual network operator and a second profile that specifically enables telecommunication through the second mobile network operator providing telecommunication service to the second set of clients of the mobile virtual network operator, and (iii) providing, by the mobile virtual network operator after preloading the subscriber identity module, the subscriber identity module to a specific client of the mobile virtual network operator such that the mobile virtual network operator is enabled to remotely switch an active profile of the subscriber identity module between the first profile and the second profile.

In examples of the fourth embodiment, a system can comprise: (i) at least one physical computing processor of a computing device and (ii) a non-transitory computer-readable medium that has instructions stored thereon that, when executed by the at least one physical computing processor, cause the computing device to perform operations comprising: (i) establishing, by a mobile virtual network operator, a configuration such that the mobile virtual network operator provides telecommunication service to a first set of clients of the mobile virtual network operator through a first mobile network operator and simultaneously provides telecommunication service to a second set of clients of the mobile virtual network operator through a second mobile network operator that is distinct from the mobile virtual network operator, (ii) preloading, by the mobile virtual network operator, a subscriber identity module with a plurality of profiles comprising a first profile that specifically enables telecommunication through the first mobile network operator providing telecommunication service to the first set of clients of the mobile virtual network operator and a second profile that specifically enables telecommunication through the second mobile network operator providing telecommunication service to the second set of clients of the mobile virtual network operator, and (iii) providing, by the mobile virtual network operator after preloading the subscriber identity module, the subscriber identity module to a specific client of the mobile virtual network operator such that the mobile virtual network operator is enabled to remotely switch an active profile of the subscriber identity module between the first profile and the second profile.

### BRIEF DESCRIPTION OF THE DRAWINGS

For a better understanding of the present invention, reference will be made to the following Detailed Description, which is to be read in association with the accompanying drawings:

FIG. 1A shows a flow diagram for a method 100A relating to network move implementation mechanics, in some examples.

FIG. 1B shows a flow diagram for a method 100B relating to network move implementation mechanics where the mobile virtual network operator also functions as the source mobile network operator, in some examples.

FIG. 1C shows a flow diagram for a method 100C relating to network move implementation mechanics including performing an audit and remedial action for a failed network switch attempt, in some examples.

FIG. 1D shows a flow diagram for a method 100D relating to network move implementation mechanics including pre-loading multiple network profiles onto a subscriber identity module, in some examples.

FIG. 2A shows a diagram illustrating a network move process from a first mobile network operator to a second mobile network operator, in some examples.

FIG. 2B shows a continuation of the diagram from FIG. 2A, in some examples.

FIG. 3 shows a flow diagram detailing steps in a network move process, in some examples.

FIG. 4A shows a diagram illustrating a network move process from one mobile network operator to another for machine-to-machine devices, in some examples.

FIG. 4B shows a continuation of the diagram from FIG. 4A, in some examples.

FIG. 5 shows a flow diagram detailing steps in a network move process between mobile network operators, in some examples.

FIG. 6 shows a flow diagram for a method relating to resynchronizing SIM state during a failed network switch, in some examples.

FIG. 7 shows a flow diagram for a method relating to pre-allocation and management of multiple network profiles, in some examples.

FIG. 8 shows a flow diagram of a test plan for network move functionality, in some examples.

FIG. 9 shows a diagram illustrating interactions between various systems during a network move process, in some examples.

FIG. 10 shows a series of diagrams illustrating stages of a network move process, in some examples.

FIG. 11 shows a flow diagram for a method relating to a subscriber identity module audit, in some examples.

FIG. 12 shows a flow diagram for a method relating to pre-loading subscriber identity module cards, in some examples.

FIG. 13 shows a flow diagram for a method relating to tagging an internal network move order, in some examples.

FIG. 14 shows a flow diagram for a method relating to predictive network move initiation, in some examples.

FIG. 15 shows a comparison illustration of related and new network switching methods, in some examples.

FIG. 16 shows a multi-panel illustration detailing various aspects of the invisible network switch process, in some examples.

FIG. 17 shows a box diagram illustrating the process flow of an invisible network switch, in some examples.

FIG. 18 shows a multi-panel illustration of the port out interceptor process, in some examples.

FIG. 19 shows a detailed illustration of the network switching process with emphasis on the port out interceptor, in some examples.

FIG. 20 shows a box diagram illustrating the detailed flow of the interceptor process, in some examples.

FIG. 21 shows a multi-panel illustration of the network switch audit process, in some examples.

FIG. 22 shows a detailed illustration of the audit process, in some examples.

FIG. 23 shows a box diagram illustrating the audit and remediation process flow, in some examples.

FIG. 24 shows a multi-panel illustration of the subscriber identity module profile pre-allocation process, in some examples.

FIG. 25 shows a detailed illustration of the subscriber identity module profile pre-allocation process, in some examples.

FIG. 26 shows a box diagram illustrating the subscriber identity module profile pre-allocation and usage process flow, in some examples.

FIG. 27 shows a diagram of an example computing system that may facilitate the performance of one or more of the methods described herein, in some examples.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

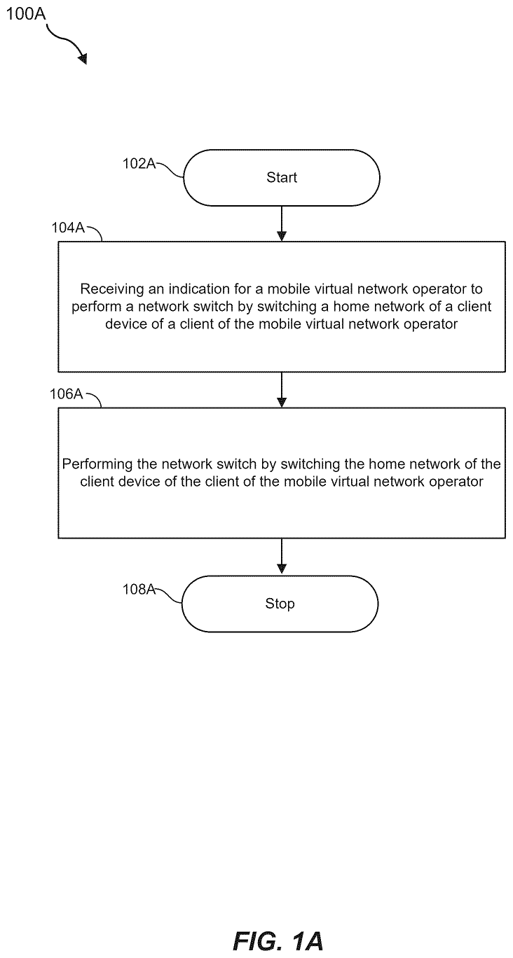

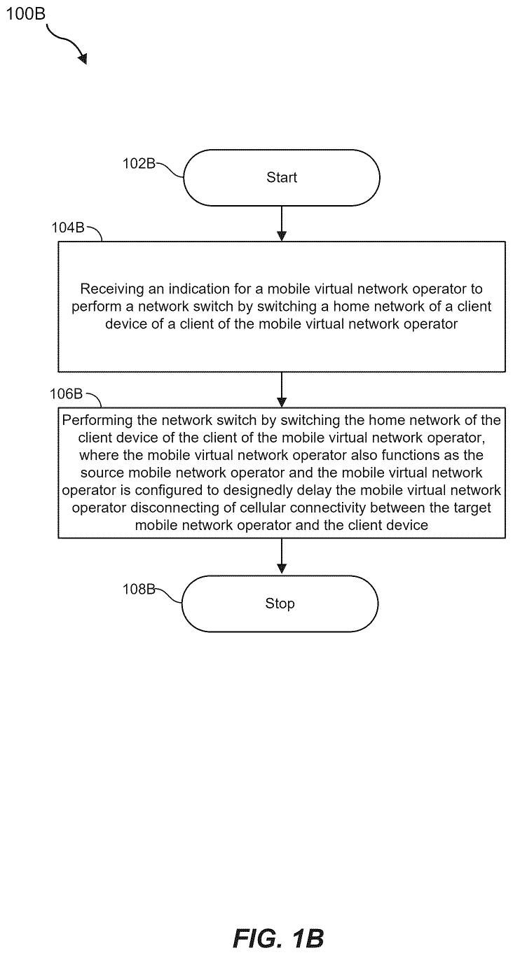

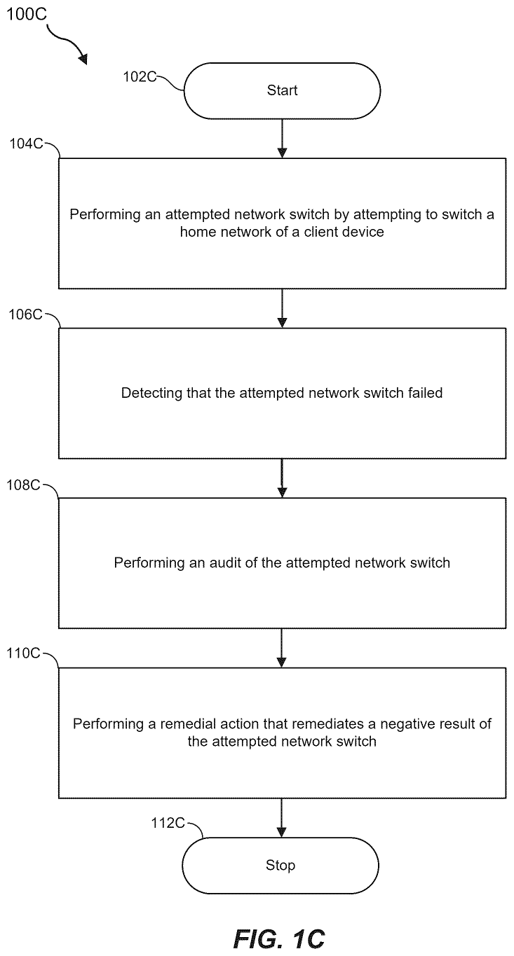

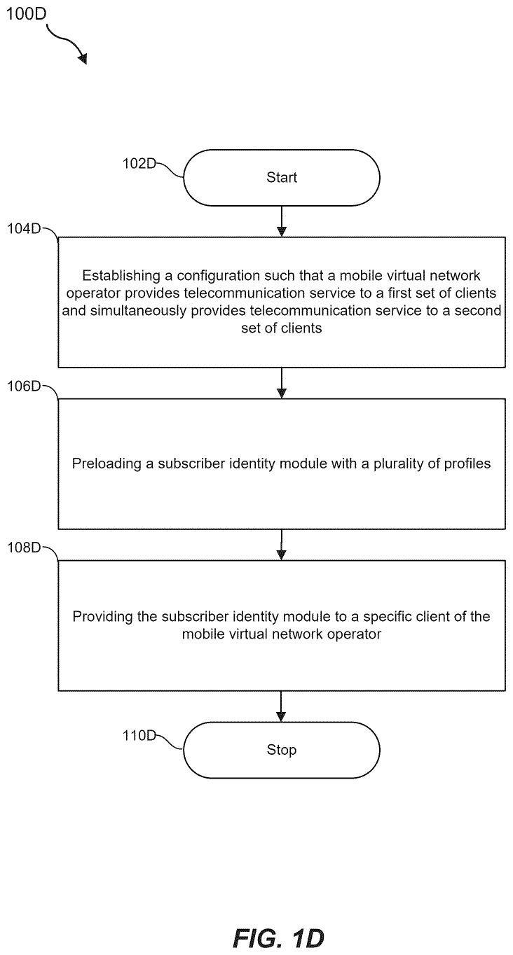

FIG. 1A shows a flow diagram for a method relating to network move implementation mechanics. The method begins at start step 102A. At step 104, the method includes receiving, at a mobile virtual network operator, an indication for a mobile virtual network operator to perform a network switch by switching a home network of a client device of a client of the mobile virtual network operator from a source network infrastructure of a source mobile network operator that is serving the client for the mobile virtual network operator to a target network infrastructure of a target mobile network operator that is serving clients for the mobile virtual network operator. At step 104A, the method further includes performing, by the mobile virtual network operator in response to receiving the indication, the network switch by switching the home network of the client device of the client of the mobile virtual network operator from the source network infrastructure of the source mobile network operator that is serving the client for the mobile virtual network operator to the target network infrastructure of the target mobile network operator that is serving clients for the mobile virtual network operator. The method ends at stop step 108A. In some examples, electronic communication between the mobile virtual network operator and the client device of the client configuring the client device for the network switch can be performed entirely through cellular connectivity between the mobile virtual network operator and the client device over-the-air.

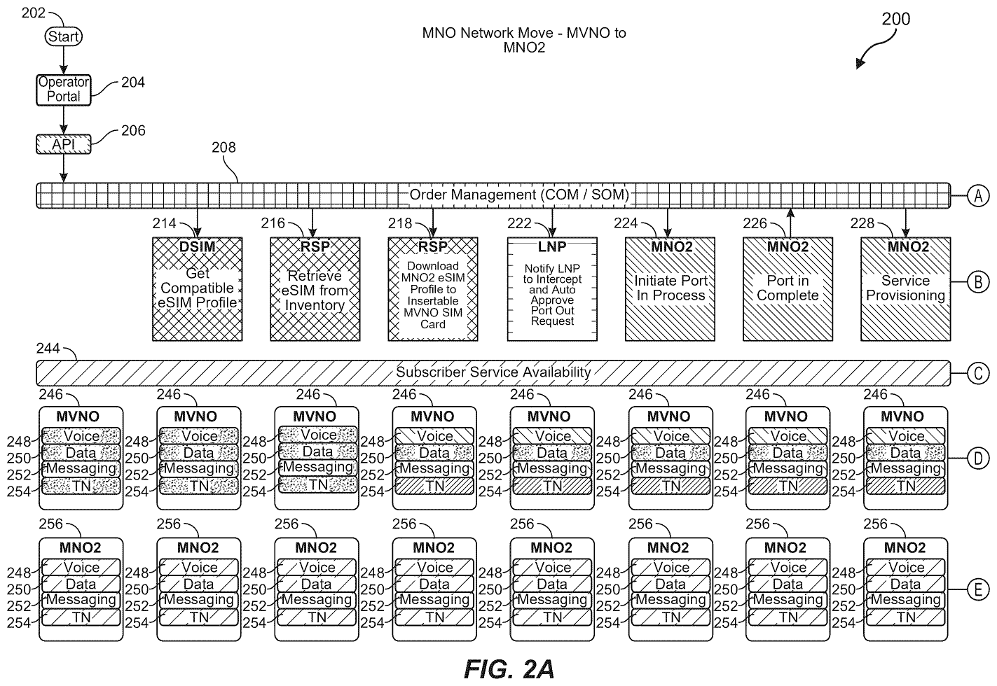

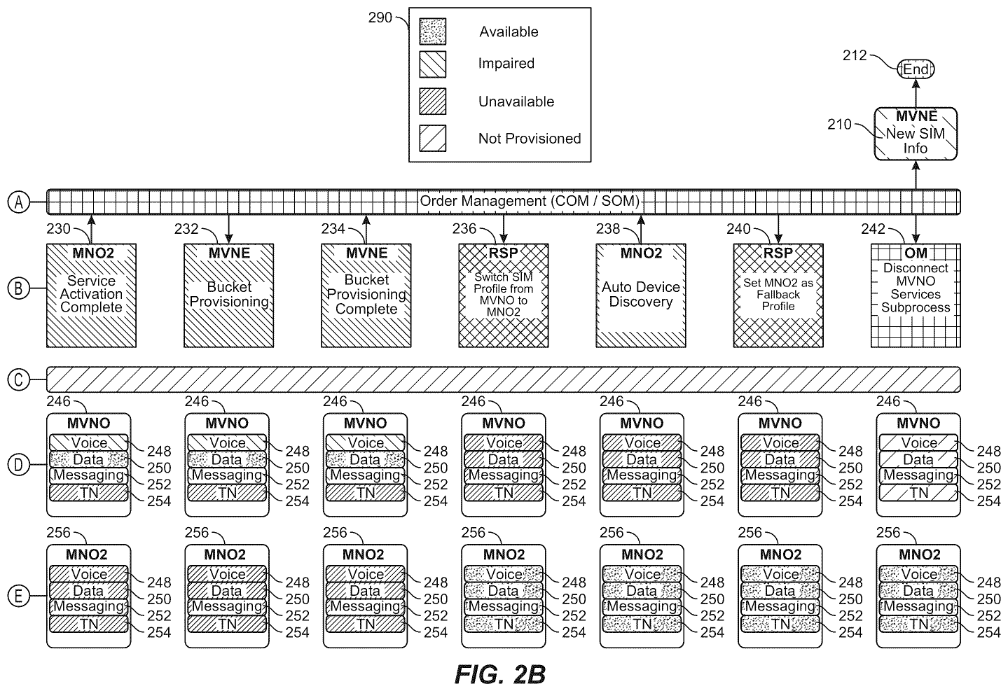

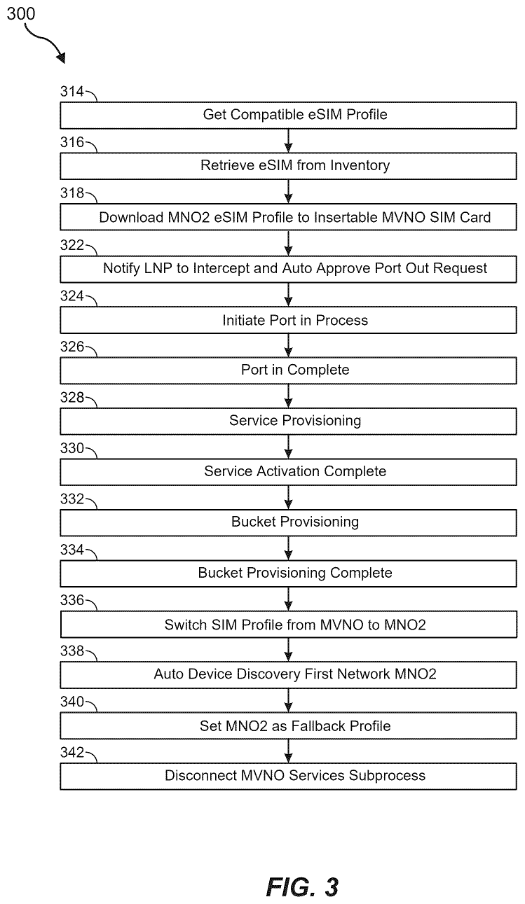

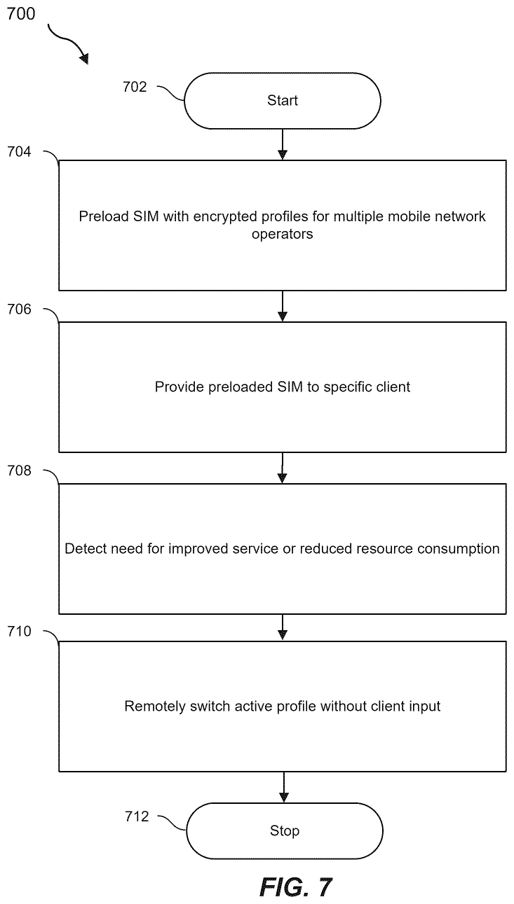

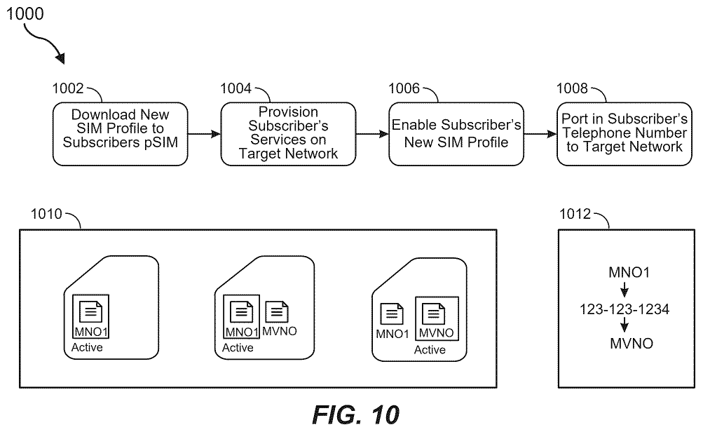

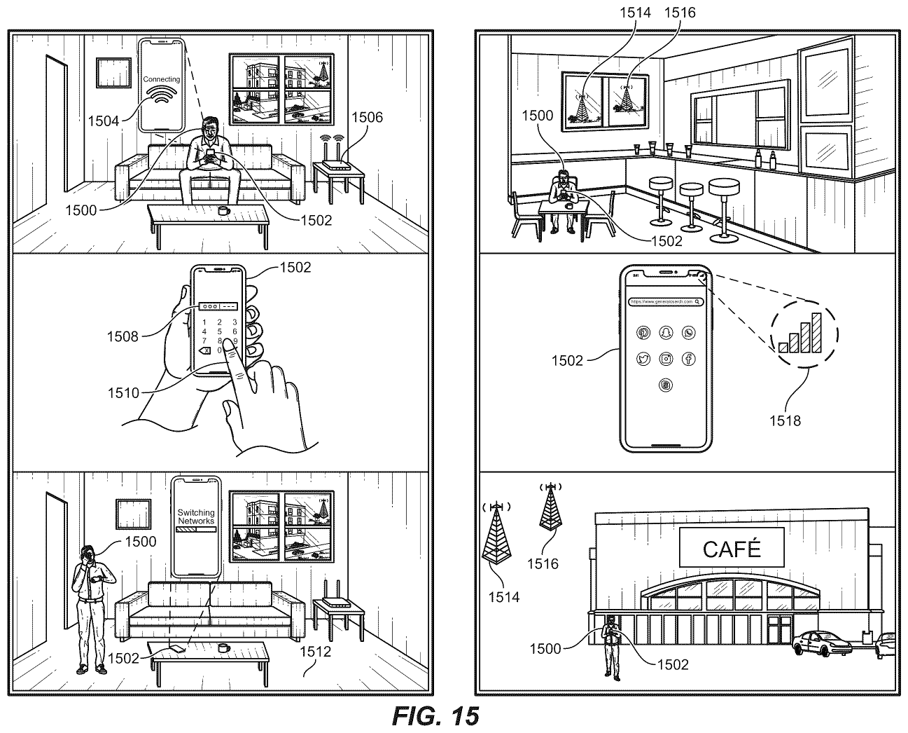

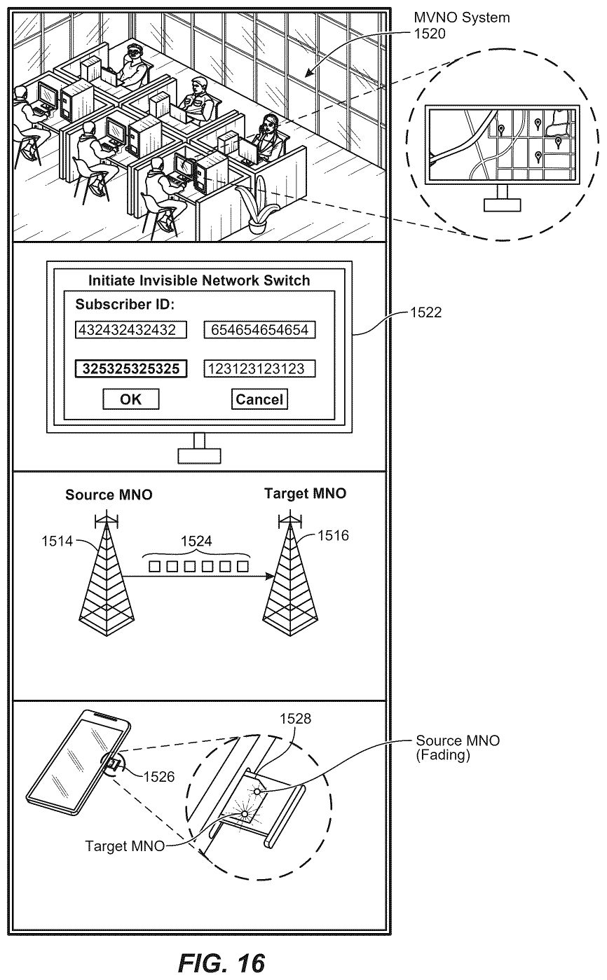

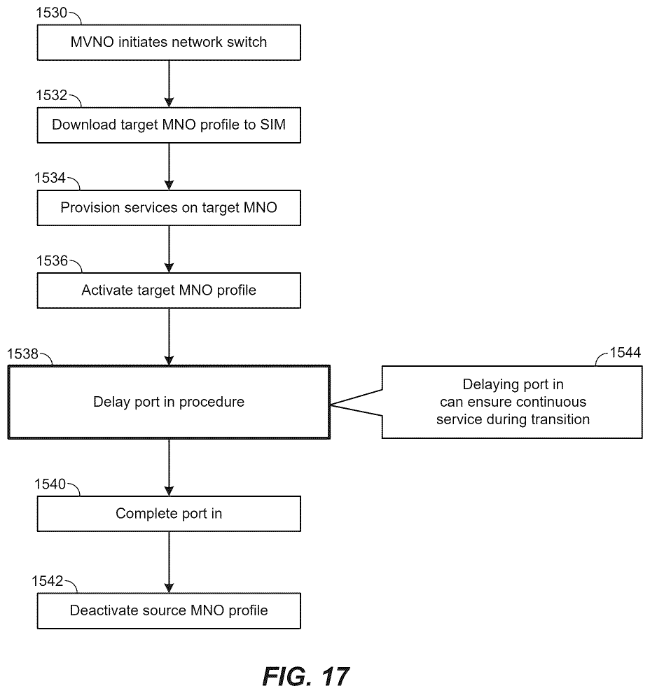

This method outlines an approach for transitioning a client's network connection between different mobile network operators without relying on Wi-Fi connectivity. The process illustrated in FIG. 1A can serve as a reference for various implementations. Subsequent figures, particularly FIGS. 2A, 2B, and 3, can provide more detailed insights into the specific steps and components that can be involved in this network switching process. For instance, FIG. 2A-2B can illustrate the interactions between various systems during a network move from one mobile network operator to another, while FIG. 3 can offer a detailed flow diagram of the individual steps involved in the switching process. The concept of performing the switch entirely over cellular networks, an aspect highlighted in the method of FIG. 1A, can be further elaborated in discussions related to FIGS. 15, 16, and 17. FIG. 15 can provide a comparison illustration of related and new network switching methods, visually representing the advantages of the approach outlined in FIG. 1A. FIG. 16 can offer a multi-panel illustration detailing various aspects of the invisible network switch process, further expanding on the method's implementation. FIG. 17 can present a box diagram illustrating the process flow of the invisible network switch, aligning with the steps outlined in FIG. 1A. The network architecture supporting such switches can be explored in FIG. 7, providing context for the infrastructure requirements. FIG. 10 can illustrate the stages of the network move process, aligning with the steps outlined in FIG. 1A. By focusing on cellular-based switching, this method can address challenges related to service continuity and user experience during network transitions. The approach introduced in FIG. 1A can potentially influence how mobile virtual network operators manage and optimize their services in a dynamic telecommunications landscape.

FIG. 1B shows a flow diagram for a method relating to network move implementation mechanics. The method begins at start step 102B. At step 104, the method includes receiving, at a mobile virtual network operator, an indication for a mobile virtual network operator to perform a network switch by switching a home network of a client device of a client of the mobile virtual network operator from a source network infrastructure of a source mobile network operator that is serving the client for the mobile virtual network operator to a target network infrastructure of a target mobile network operator that is serving clients for the mobile virtual network operator. At step 106B, the method further includes performing, by the mobile virtual network operator in response to receiving the indication, the network switch by switching the home network of the client device of the client of the mobile virtual network operator from the source network infrastructure of the source mobile network operator that is serving the client for the mobile virtual network operator to the target network infrastructure of the target mobile network operator that is serving clients for the mobile virtual network operator. The method ends at stop step 108B. In some examples, the mobile virtual network operator can also function as the source mobile network operator, and the mobile virtual network operator can be configured to designedly delay the mobile virtual network operator disconnecting cellular connectivity between the source mobile network operator and the client device until after the mobile virtual network operator establishes cellular connectivity between the target mobile network operator and the client device.

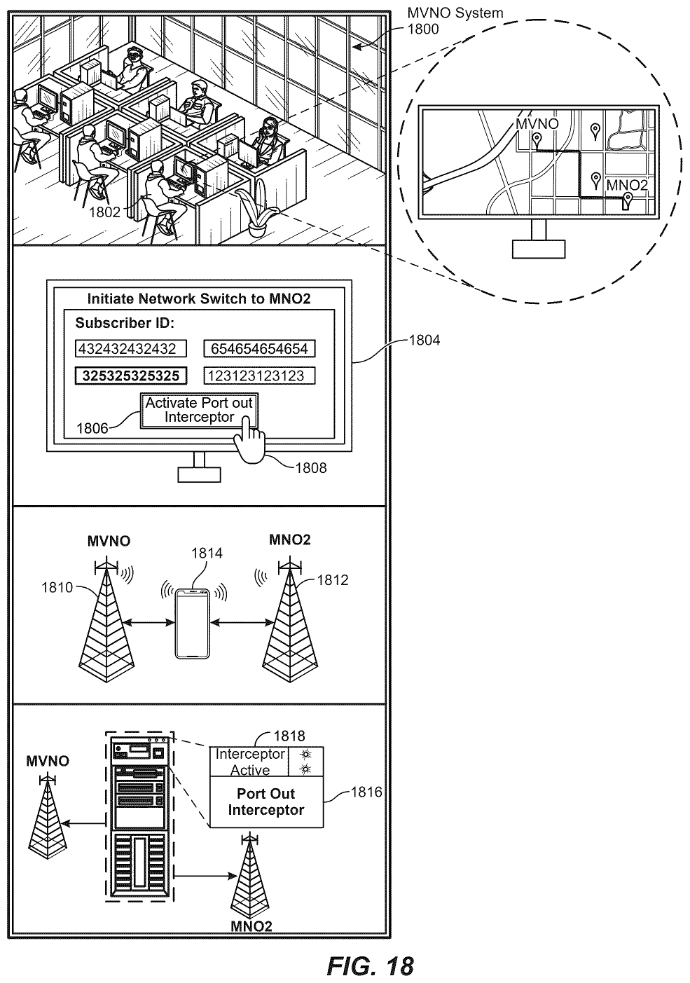

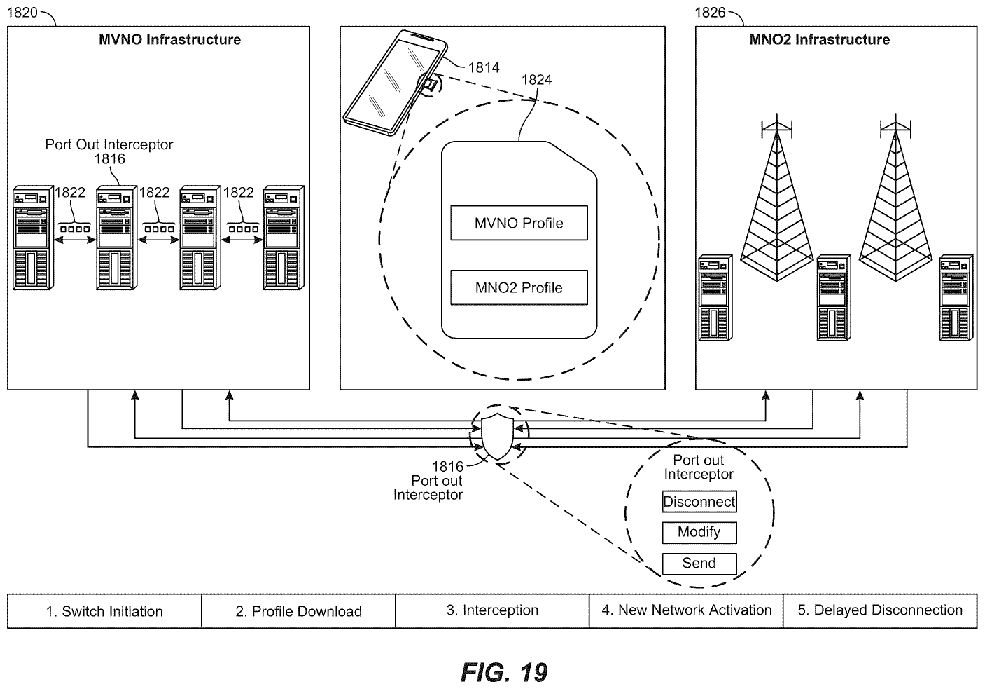

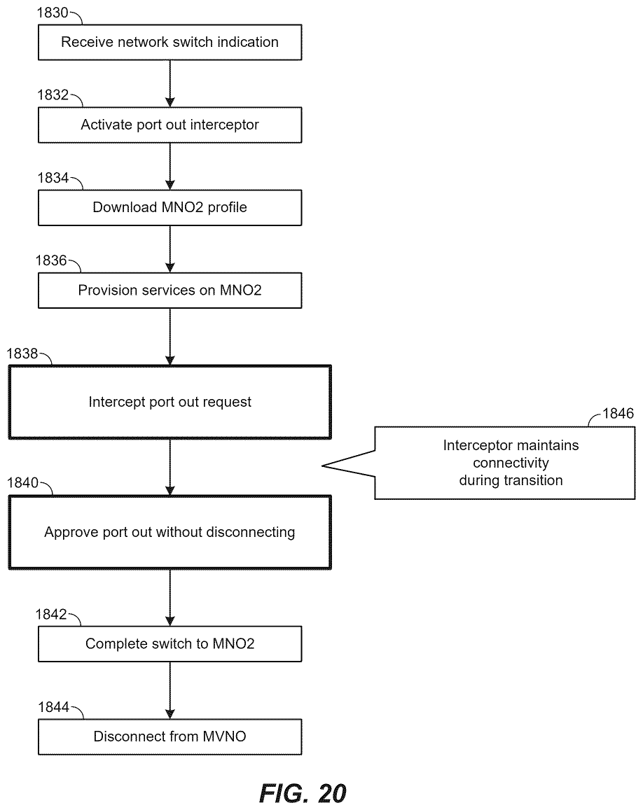

In various examples, this method introduces an approach for managing network switches when the mobile virtual network operator functions as both the source mobile network operator and the orchestrator of the switch. The process illustrated in FIG. 1B can be particularly relevant when transitioning clients from the mobile virtual network operator's own network infrastructure to that of a partner mobile network operator. FIGS. 18, 19, and 20 can provide more detailed insights into the specific mechanisms involved in this process, particularly the port out interception technique that enables the delayed disconnection described in FIG. 1B. FIG. 18 can offer an illustration of the port out interceptor process, visually representing how the mobile virtual network operator maintains control over the switching process. FIG. 19 can present a detailed illustration of the network switching process with emphasis on the port out interceptor, further expanding on the method's implementation. FIG. 20 can show a box diagram illustrating the detailed flow of the interceptor process, aligning with the steps outlined in FIG. 1B. The concept of maintaining simultaneous connectivity during the switch, which can correspond to one aspect of the method in FIG. 1B, can be further explored in FIGS. 2A and 2B, which illustrate the stages of a network move process. The network architecture supporting this type of switch can be examined in FIG. 7, providing context for the infrastructure that enables the mobile virtual network operator to function in dual roles. By implementing this approach of delayed disconnection, the method outlined in FIG. 1B can address challenges related to maintaining service continuity during complex network transitions, potentially enhancing the flexibility and reliability of mobile virtual network operator services.

FIG. 1C shows a flow diagram for a method relating to network move implementation mechanics. The method begins at start step 102C. At step 104C, the method includes performing, by a mobile virtual network operator in response to receiving an indication to perform a network switch, an attempted network switch by attempting to switch a home network of a client device of a client of the mobile virtual network operator from a source network infrastructure of a source mobile network operator that is serving the client for the mobile virtual network operator to a target network infrastructure of a target mobile network operator that is serving clients for the mobile virtual network operator. At step 106C, the method further includes detecting, by the mobile virtual network operator after performing the attempted network switch, that the attempted network switch failed. At step 108C, the method further includes performing, by the mobile virtual network operator in response to detecting that the attempted network switch failed, an audit of the attempted network switch. At step 110C, the method further includes performing, by the mobile virtual network operator in response to a negative result of the audit of the attempted network switch, a remedial action that remediates the negative result of the attempted network switch. The method ends at stop step 112C. In some examples, the remedial action can comprise successfully completing the attempted network switch or performing a reverse network switch back from the target network infrastructure of the target mobile network operator to the source network infrastructure of the source mobile network operator.

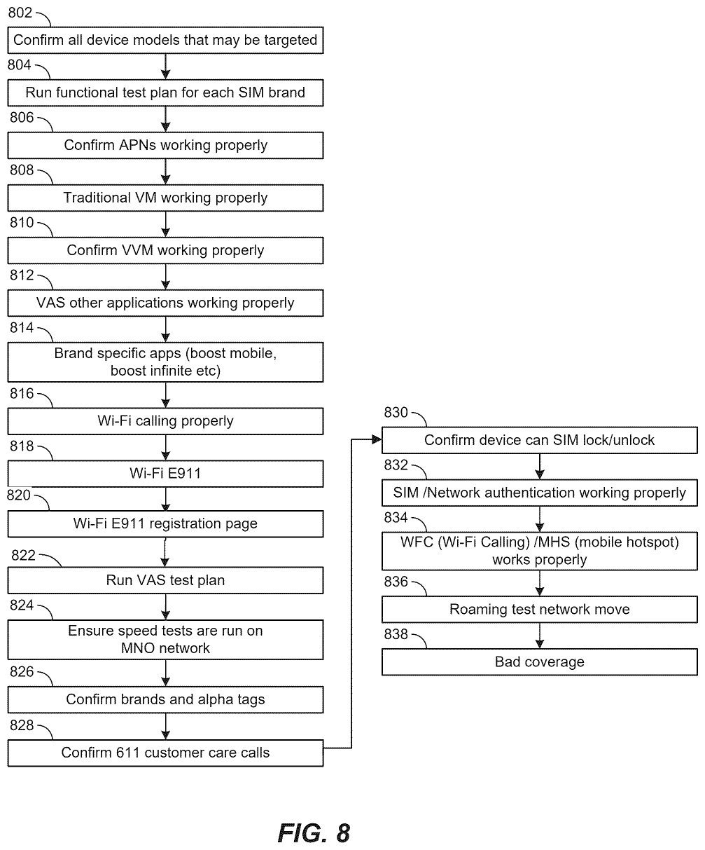

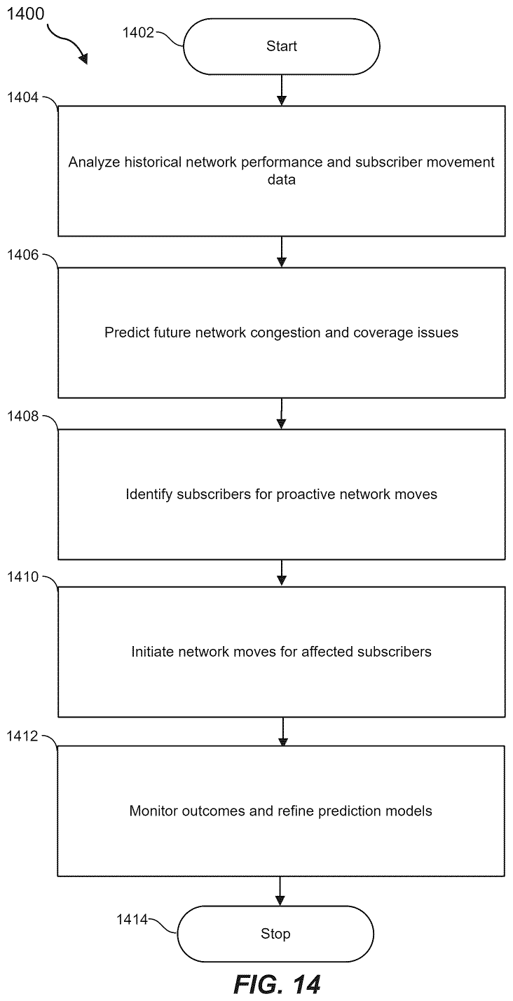

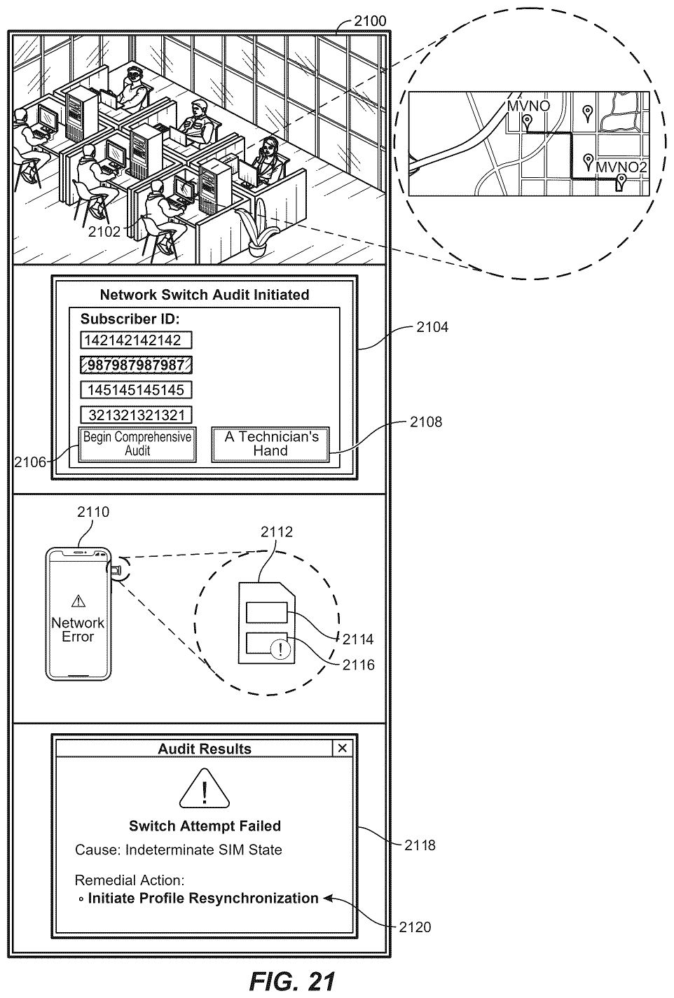

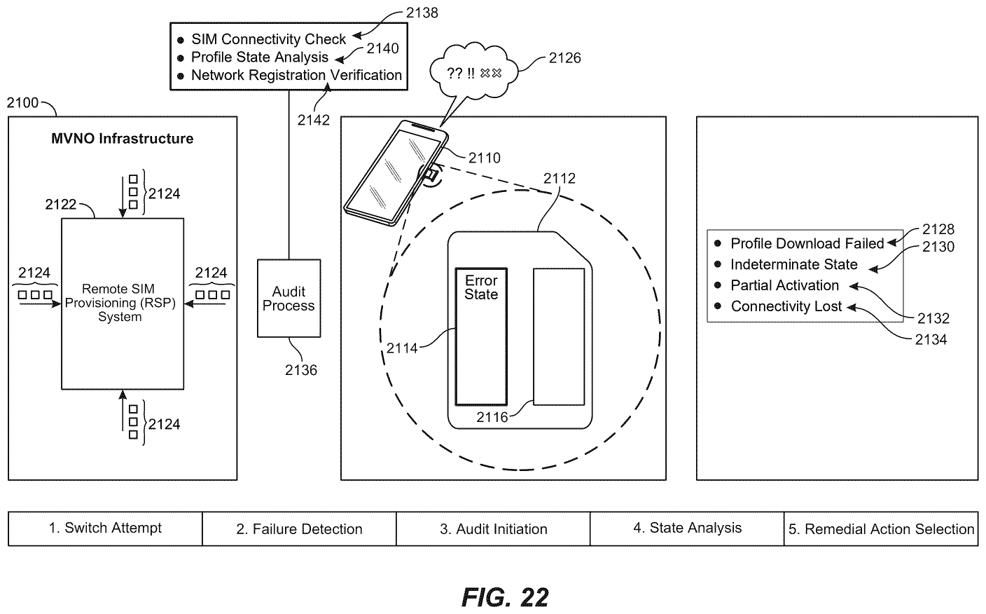

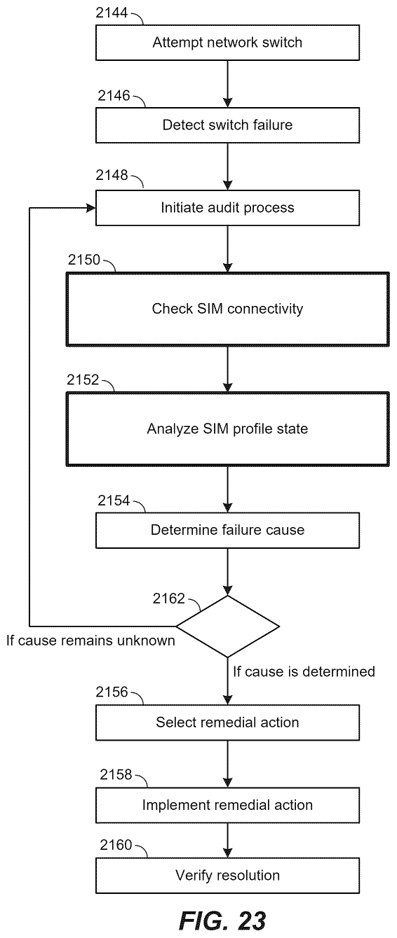

In various examples, this method can address the helpful issue of handling failed network switch attempts and introduces a systematic approach for auditing and remediation. The process illustrated in FIG. 1C can be particularly relevant in scenarios where network transitions encounter unexpected complications. FIGS. 21, 22, and 23 can provide more detailed insights into the specific mechanisms that can be involved in this process. FIG. 21 can offer an example illustration of the network switch audit process, visually representing how the mobile virtual network operator identifies and responds to switch failures. FIG. 22 can present a detailed example illustration of the audit process, further expanding on the method's implementation and the various states a switch attempt might encounter. FIG. 23 can show a box diagram example illustrating the audit and remediation process flow, aligning closely with the steps outlined in FIG. 1C. The concept of detecting switch failures and performing audits, which can be helpful aspects of the method in FIG. 1C, can be further explored in FIG. 14, which illustrates various states in a network move order process. FIG. 8 can provide insights into the testing plan for network move functionality, which can be relevant to the audit process described in FIG. 1C. FIGS. 2A and 2B can illustrate the stages of a successful network move process, providing a contrast to the failure scenarios addressed in FIG. 1C. By implementing this approach of systematic auditing and remediation, the method outlined in FIG. 1C can address challenges related to maintaining service reliability and continuity even in the face of switch failures, potentially enhancing the robustness and resilience of mobile virtual network operator services.

FIG. 1D shows a flow diagram for a method relating to network move implementation mechanics. The method begins at start step 102D. At step 104D, the method includes establishing, by a mobile virtual network operator, a configuration such that the mobile virtual network operator provides telecommunication service to a first set of clients of the mobile virtual network operator through a first mobile network operator and simultaneously provides telecommunication service to a second set of clients of the mobile virtual network operator through a second mobile network operator that is distinct from the mobile virtual network operator. At step 106D, the method further includes preloading, by the mobile virtual network operator, a subscriber identity module with a plurality of profiles comprising a first profile that specifically enables telecommunication through the first mobile network operator providing telecommunication service to the first set of clients of the mobile virtual network operator and a second profile that specifically enables telecommunication through the second mobile network operator providing telecommunication service to the second set of clients of the mobile virtual network operator. At step 108D, the method also includes providing, by the mobile virtual network operator after preloading the subscriber identity module, the subscriber identity module to a specific client of the mobile virtual network operator such that the mobile virtual network operator is enabled to remotely switch the active profile of the subscriber identity module between the first profile and the second profile. The method ends at stop step 110D.

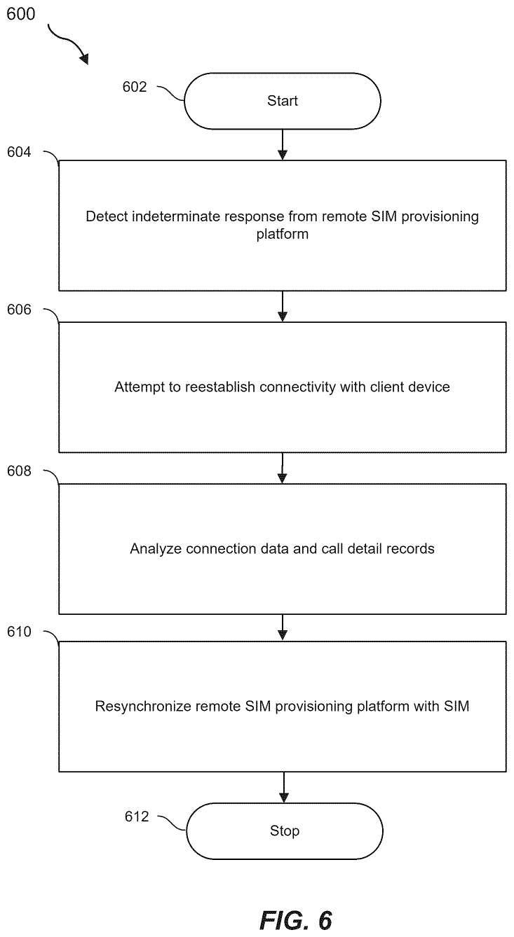

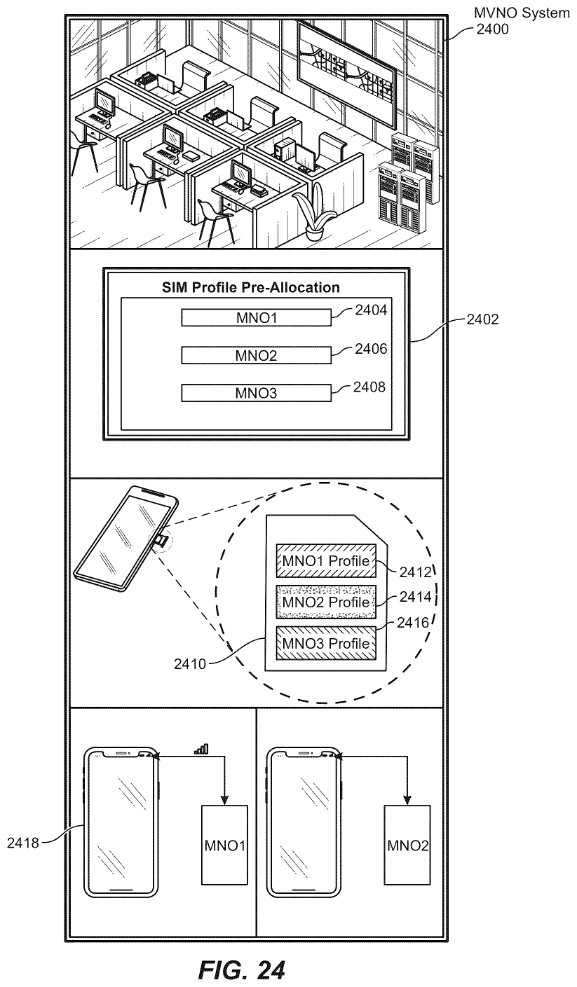

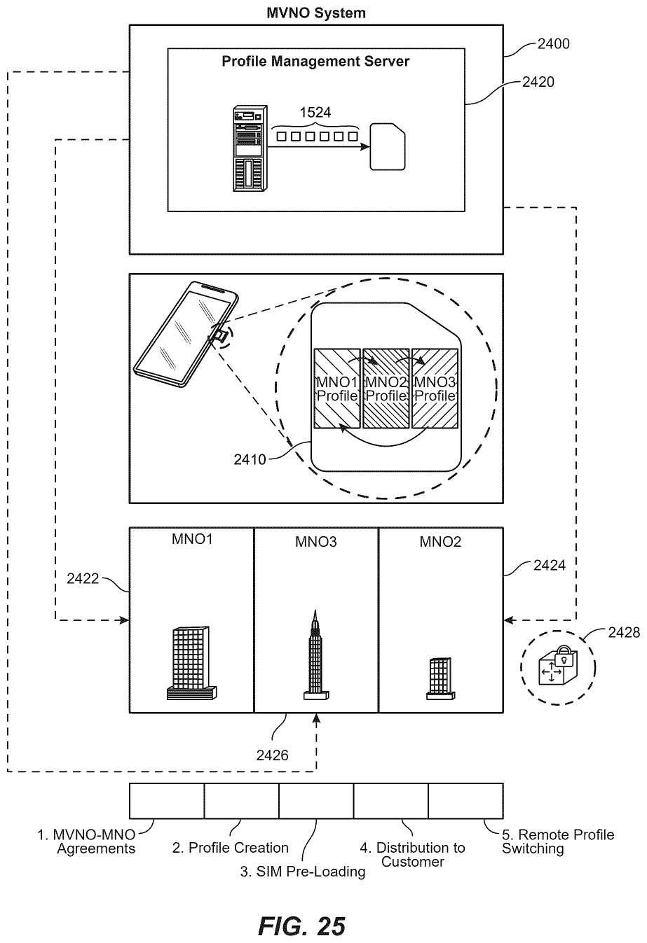

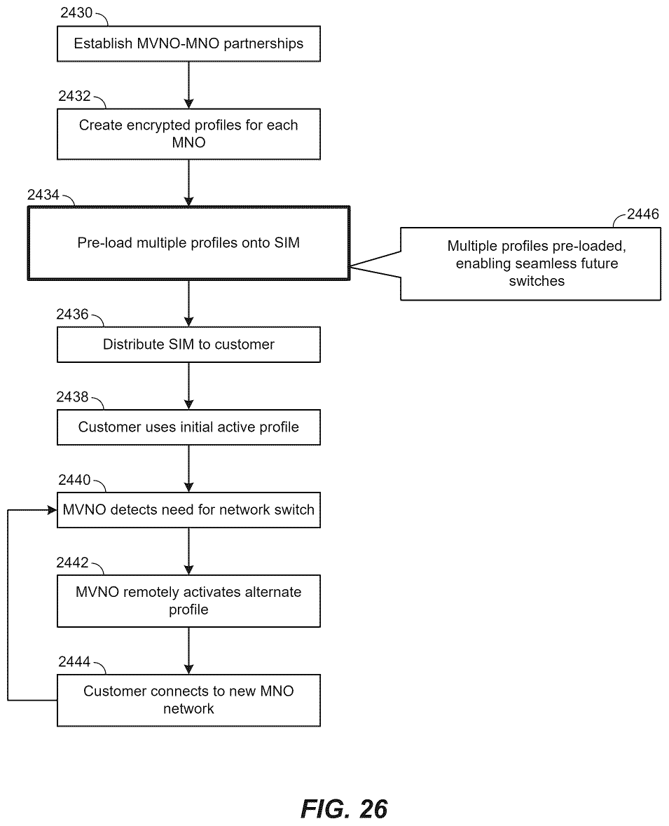

This method introduces an approach for preloading multiple network profiles onto a single subscriber identity module, enabling flexible network switching capabilities. The process illustrated in FIG. 1D can be particularly relevant in scenarios where mobile virtual network operators aim to optimize their ability to transition clients between different network infrastructures. FIGS. 24, 25, and 26 can provide more detailed insights into the specific mechanisms involved in this process. FIG. 24 can offer an illustration of an example SIM profile pre-allocation process, visually representing how multiple profiles can be loaded onto a single SIM card. FIG. 25 can present a detailed example illustration of the SIM profile pre-allocation process, further expanding on the method's implementation and the interactions between the mobile virtual network operator and multiple mobile network operators. FIG. 26 can show an example box diagram illustrating the SIM profile pre-allocation and usage process flow, aligning closely with the steps outlined in FIG. 1D. The concept of managing multiple network profiles on a single SIM, which is one aspect of the method in FIG. 1D, can be further explored in FIG. 6, which illustrates components and interactions in a network move system. FIG. 7 can provide insights into the network architecture that supports such multi-profile configurations. FIGS. 2A and 2B can illustrate the stages of a network move process, which can be potentially streamlined by the pre-loading approach described in FIG. 1D. By implementing this approach of pre-loading multiple network profiles, the method outlined in FIG. 1D can address challenges related to network flexibility and rapid transitions, potentially enhancing the agility and efficiency of mobile virtual network operator services.

FIGS. 2A and 2B collectively illustrate a detailed process flow for a network move from a mobile virtual network operator (MVNO) to a second mobile network operator (MNO2). This diagram, labeled as “MNO Network Move—MVNO to MNO2” 200, can provide a comprehensive view of the various stages and systems involved in the network transition. The process can begin at the start point 202, initiating a sequence of events that can unfold from left to right across the figures, representing the progression of time. At the top of the diagram, the mobile virtual network operator can interact with the network move using operator portal 204, which can implement application programming interface 206. As shown, these components can interact with order management 208, which can help to orchestrate the overall network move process, as discussed further below. The diagram can be structured with a series of vertical columns, each potentially representing a distinct stage in the network move process. Within these columns, various boxes can indicate the status of different services at either the mobile virtual network operator or the target mobile network operator. The boxes labeled 246 can pertain to the MVNO's services, while those labeled 256 can correspond to MNO2's services. These boxes can be consistently aligned vertically, potentially allowing for a clear comparison of the state of services on both networks at any given point in the process. This visual representation may enable a quick understanding of how services can transition from one network to another over time, potentially providing insights into the continuity of service during the move process. In legend 290 on FIG. 2B, the color or hatching coding of these boxes—“Available,” “Impaired,” “Unavailable,” “Not Provisioned”—can offer an intuitive way to track the status of various services throughout the transition.

The process flow can be divided into a series of steps, numbered from 214 to 242, which transition through the network move operation. These steps can be executed sequentially, with each step potentially building upon the previous one to facilitate a smooth transition of services from the MVNO to MNO2. At the outset of the process, we can see the initial state of services for both the MVNO and MNO2. Across subscriber service availability 244, the MVNO boxes 246 can show that voice 248, data 250, messaging 252, and telephone number (TN) 254 services may be initially active on the MVNO network. Conversely, the MNO2 boxes 256 can indicate that these services may not yet be provisioned on the MNO2 network. This initial state can set the stage for the subsequent steps in the network move process, which can lead to the transition of all services from one network to another while maintaining service continuity. The first action in the process can be the “Get Compatible eSIM Profile” step 214. This step may involve the MVNO's DSIM component that provides compatible eSIM profiles. Relatedly, the remote SIM provisioning (RSP) system at step 216 can be responsible for managing the electronic SIM (eSIM) profiles that may allow devices to connect to different networks without physical SIM card changes. Step 214 can be helpful in preparing for the network move, as it may identify the appropriate eSIM profile that can be compatible with MNO2's network. The use of eSIM technology in this process can represent an advancement over related physical SIM cards, potentially allowing for more flexible and efficient network switching capabilities. Following this, the process can move to the “Retrieve eSIM from Inventory” step 216, which may be handled by the RSP system. This step can involve selecting an appropriate eSIM profile from the MVNO's inventory that may be compatible with MNO2's network. The inventory management of eSIM profiles can be a complex task, potentially requiring the MVNO to maintain a diverse range of profiles to accommodate various network partners and device types. This step can help ensure that the correct profile is selected for the specific client device and target network, potentially laying the groundwork for a successful network transition.

The next step can be “Download MNO2 eSIM Profile to Insertable MVNO SIM Card” 218. This step can be helpful in preparing the client's device for the impending network switch by potentially loading the MNO2 profile onto the SIM card. This approach may allow for a seamless transition without requiring physical SIM card replacement. The ability to download and install new network profiles over-the-air can potentially simplify the network move process from the client's perspective, possibly eliminating the need for in-person visits to retail locations or the physical handling of SIM cards. The successful completion of this step can help ensure that the client's device is technically prepared to connect to MNO2's network, even while still actively using the MVNO's services.

Moving forward, the next step can include the “Notify LNP to Intercept and Auto Approve Port Out Request” step 222. LNP can stand for Local Number Portability, and this step can be helpful in facilitating the transfer of the client's phone number from the MVNO to MNO2 while maintaining service continuity. The interception and auto-approval of the port out request can be an approach that may allow for enhanced control and timing of the network switch process. This step can involve interactions between the MVNO's systems and the broader telecommunications ecosystem that manages number portability. By intercepting and automatically approving the port out request, the MVNO may maintain control over the timing of the actual number transfer, potentially allowing for better synchronization with other aspects of the network move process. This level of control can be beneficial in maintaining service continuity and potentially minimizing any disruptions that might occur during the transition.

The next steps, “Initiate Port In Process” 224 and “Port in Complete” 226, can mark the formal transfer of the client's phone number from the MVNO to MNO2. These steps may typically be handled by the LNP systems of both operators. The porting process can involve updating various databases and routing systems across the telecommunications network to help ensure that calls and messages to the client's number are correctly directed to MNO2's network. This process can be complex and time-sensitive, potentially requiring coordination between the involved parties. The successful completion of these steps can help ensure that the client's phone number is fully associated with MNO2's network, potentially allowing for incoming and outgoing communications to function correctly on the new network. During this transition, there may be a brief period where the number is in a state of flux, potentially leading to the “Impaired” status indicated in the service status boxes.

As we move to the right side of the diagram, the reader sees the “Service Provisioning” step 228, followed by “Service Activation Complete” 230. These steps can involve setting up and activating the client's services on the MNO2 network. During this phase, there can be changes in the status boxes 256 for MNO2, potentially indicating that services are being provisioned and activated. The service provisioning step can involve configuring MNO2's network elements to recognize and support the client's device and associated services. This may include setting up authentication parameters, defining service levels, and establishing any custom features or settings associated with the client's account. The activation process can then bring these configured services online, potentially making them available for use by the client.

The “Bucket Provisioning” 232 and “Bucket Provisioning Complete” 234 steps can relate to setting up the client's service plan details, such as data allowances, on the MNO2 network. These steps might involve interaction with a mobile virtual network enabler (MVNE) platform, such as a multinational networking and telecommunications company that is partnering with the MNO2 network. The concept of “bucket provisioning” can refer to the allocation of service quotas or allowances, such as minutes of voice calls, number of text messages, or gigabytes of data. This process can help ensure that the client's service plan on MNO2's network matches what they had on the MVNO's network, potentially maintaining consistency in the level of service provided. The involvement of an MVNE platform in this process can highlight the complex ecosystem of telecommunications services, where specialized platforms may provide helpful functionalities to enable MVNOs and MNOs to manage their services more efficiently. The successful completion of bucket provisioning can help ensure that the client's service plan is fully configured on MNO2's network, potentially ready to support their usage patterns and requirements.

The “Switch SIM Profile from MVNO to MNO2” step 236, performed by the Remote SIM Provisioning (RSP) system, can be a beneficial juncture in the network move process. This step can involve instructing the client's device to activate the MNO2 eSIM profile that was previously downloaded. This transition can be a nuanced operation, as it can involve changing the active network connection of the device while aiming to maintain service continuity. The execution of this step can be conducive to facilitating a smooth transition from the MVNO's network to MNO2's network. During this process, the device can be instructed to deactivate the current MVNO profile and activate the newly downloaded MNO2 profile. This switch can occur rapidly, potentially minimizing any perceptible service interruption for the client. The system can be designed to monitor this transition closely, as any issues during this step could potentially affect the success of the entire network move operation.

The “Auto Device Discovery” step 238, executed by MNO2, can involve the client's device automatically detecting and connecting to MNO2's network using the newly activated profile. This process can be designed to happen without any manual intervention from the client, potentially contributing to the overall seamlessness of the network move experience. During this step, the device can scan for available MNO2 network signals, authenticate using the new profile credentials, and establish a connection to the nearest cell tower. This process can leverage standard cellular protocols and can typically complete within a short time frame. The system can be configured to verify successful network attachment, potentially initiating fallback procedures if any issues are detected. This automatic discovery and attachment process can be a beneficial factor in ensuring that the client experiences minimal disruption during the network transition.

The “Set MNO2 as Fallback Profile” step 240 can be a helpful measure to enhance the reliability of the network transition. By setting the MNO2 profile as the fallback option, the system can help ensure that the device will preferentially connect to MNO2's network in the future, even if it temporarily loses connection. This step can be beneficial in solidifying the network move and reducing the likelihood of unintended reversions to the previous network. The fallback profile setting can typically be stored in the device's SIM card or internal memory, ensuring it persists even if the device is powered off or restarted. This configuration can help maintain the stability of the new network connection over time, potentially reducing the need for manual interventions or customer support calls related to network connectivity issues.

The “Disconnect MVNO Services Subprocess” step 242 can represent the final severance of the client's connection to the MVNO network. This step can be executed after confirming that the client's device is successfully connected and operational on the MNO2 network. By delaying this disconnection until after the new connection is established, the system can help ensure continuity of service throughout the transition process. This step can involve updating various network databases and routing systems to reflect that the client's number is no longer associated with the MVNO network.

The “MVNE New SIM Info” step 210 can involve updating the Mobile Virtual Network Enabler (MVNE) platform with the details of the new SIM profile and network association. This step can be beneficial for ensuring that all backend systems are synchronized with the client's new network status, potentially facilitating accurate billing, customer support, and service management going forward.

Finally, the “End” step 212 can mark the conclusion of the network move process. At this point, the client's device can be fully transitioned to MNO2's network, with all services active and functioning. This step can also potentially involve final checks or confirmations to ensure the success of the move, as well as any necessary clean-up operations or database updates to reflect the completed transition. The system can perform a final series of verifications, potentially including checks on billing systems, customer databases, and network registries to ensure all records accurately reflect the completed move. Any temporary resources or flags used during the move process can be cleared or updated. The system can also generate logs and reports summarizing the network move operation, which can be useful for auditing purposes or for identifying areas of improvement in the process.

FIG. 3 illustrates a detailed flow diagram of the network move process 300, largely mirroring the steps shown in FIGS. 2A-2B. The process begins with step 314, where a compatible eSIM profile for MNO2 is obtained. In step 316, the eSIM is retrieved from inventory. Step 318 involves downloading the MNO2 eSIM profile to the insertable MVNO SIM card. Step 322 involves notifying the Local Number Portability (LNP) platform to intercept and automatically approve the port out request, which can be a helpful component in maintaining service continuity during the network move process by allowing the MVNO to retain control over the timing of the actual disconnection. Step 324 initiates the port in process, followed by step 326 where the port in is completed. Service provisioning occurs in step 328, with service activation completed in step 330. Steps 332 and 334 involve bucket provisioning and its completion, respectively. The SIM profile is switched from MVNO to MNO2 in step 336. Step 338 encompasses the auto device discovery and first network attachment to MNO2. MNO2 is set as the fallback profile in step 340. Finally, the process concludes with step 342, which involves the disconnection of MVNO services. This sequence of steps outlines the comprehensive process of transitioning a client's service from the MVNO network to the MNO2 network, leveraging eSIM technology and coordinated provisioning to minimize service interruptions.

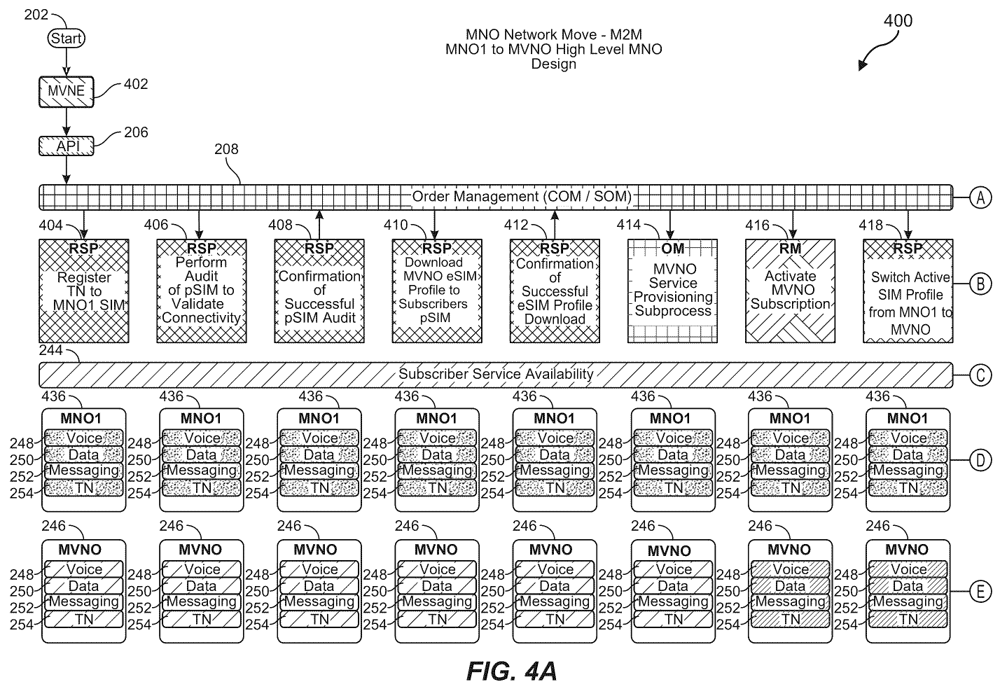

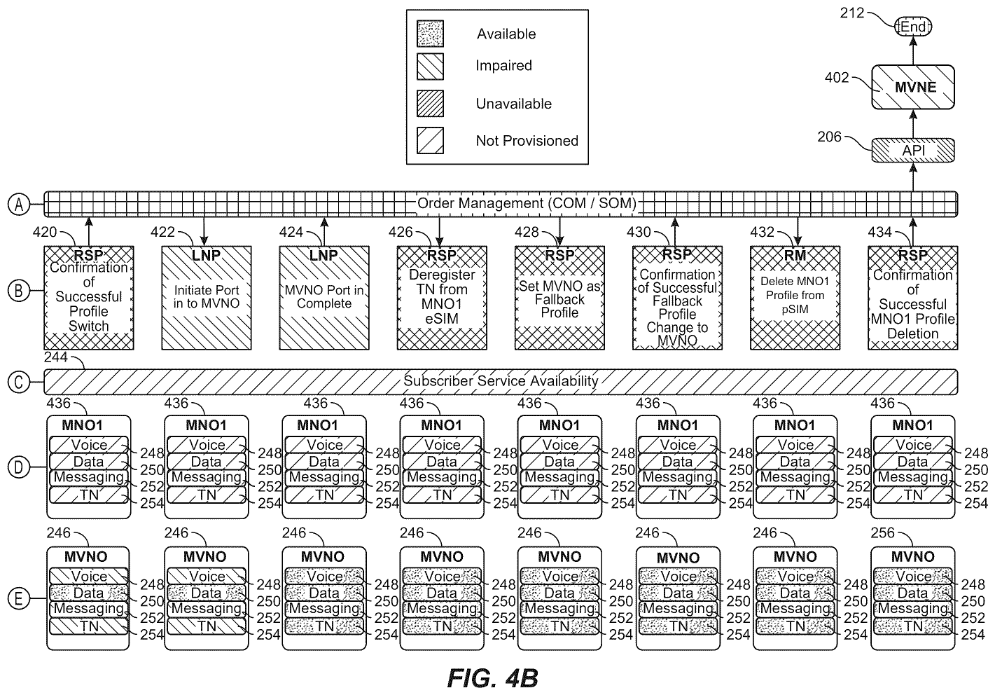

FIGS. 4A-4B illustrate a network move process from a mobile network operator (MNO1) to a mobile virtual network operator (MVNO), which moves in the opposite direction of the process shown in FIGS. 2A-2B. This change in direction can lead to a different approach for maintaining service continuity during the transition. While the MVNO to MNO2 process in FIG. 2 utilizes a port out interceptor to manage the timing of the disconnect, the MNO1 to MVNO process in FIG. 4 can achieve a similar outcome by intentionally delaying the port in request. This delay can allow for the provisioning of services on the MVNO network before initiating the actual number transfer, which can help minimize potential service interruptions. The hatching changes in FIG. 4 from FIG. 2 can reflect this different approach, as shown in the figures. These visual cues can help illustrate the nuanced differences in how services are transitioned between the two scenarios, potentially providing insights into the varying strategies employed for different types of network moves.

The API 402, with WHAPI (Wholesale API) as an example, can play a beneficial role in initiating and orchestrating the network move process. WHAPI can serve as an interface between the MVNO's systems and the underlying network infrastructure. It can handle requests for network moves, translate these requests into the appropriate actions for various components of the system, and manage the flow of information between different stages of the process. WHAPI can also provide real-time status updates and error handling capabilities, which can help ensure that the network move process can be monitored and managed effectively. This API layer can be helpful in abstracting the complexities of the network move process, potentially allowing for more efficient and streamlined operations across different network configurations and scenarios.

The mobile virtual network enabler (MVNE) 402, with Wavelo as an example, can perform specific functions to facilitate the network move process. Rather than providing generic support, the mobile virtual network enabler can actively manage the provisioning of services on the mobile virtual network operator, coordinate with the MNO1 for the transfer of subscriber information, and help ensure that the new mobile virtual network operator profile is correctly configured and activated. Wavelo, as a mobile virtual network enabler, can provide a platform that automates many of these processes, which can potentially reduce the complexity and duration of the network move for the mobile virtual network enabler. The mobile virtual network enabler's role in this process can be particularly beneficial in scenarios where the mobile virtual network enabler may not have the infrastructure or expertise to manage all aspects of the network move independently. By leveraging the capabilities of a mobile virtual network enabler, the mobile virtual network operator can potentially offer more seamless transitions for their customers while optimizing their own operational efficiency.

The introduction of element 436 in FIG. 4A-4B represents the service availability status for the MVNO network, which can be contrasted with element 246 in FIG. 2A-2B that shows the service availability status for the MNO2 network. This difference reflects the reversed direction of the network move process between the two scenarios. In FIG. 4A-4B, the MVNO network status 436 gradually transitions from “Not Provisioned” to “Available” as the process progresses, while the MNO1 network status transitions in the opposite direction. This visual representation can help illustrate how services are incrementally activated on the MVNO network while being phased out on the MNO1 network. In contrast, FIG. 2A-2B shows the MNO2 network status 246 transitioning from “Not Provisioned” to “Available” as the MVNO network status changes in the reverse. This difference in the progression of service availability between the two figures can highlight the unique challenges and approaches involved in each direction of network move, potentially demonstrating how the process can be adapted to maintain service continuity regardless of the direction of the switch.

Step 404 involves the Remote SIM Provisioning (RSP) system registering the telephone number to be moved. This step can be seen as a preparatory action, setting the stage for the subsequent network move process. It can involve updating various databases and systems to recognize that this number is about to undergo a transition. This registration process can help ensure that all relevant systems are aware of the impending change, potentially facilitating smoother coordination throughout the network move.

In step 406, the RSP performs an audit of the physical SIM (pSIM) to validate connectivity. This audit can be a beneficial measure to confirm that the device is in a suitable state for the network move process. The audit can involve checking the current status of the SIM, verifying its compatibility with the MVNO network, and ensuring that there are no outstanding issues that might impede the transition. This step can help identify and address any potential problems early in the process, potentially reducing the likelihood of complications during later stages of the network move. In some examples, the audit process can be included within the workflow of FIGS. 2A-2B as well (see also FIG. 1C).

Step 408 represents the confirmation of a successful pSIM audit. This confirmation can serve as a green light to proceed with the subsequent steps of the network move process. A successful audit can indicate that the SIM is in good standing, has the necessary capabilities for the transition, and is ready for the profile switch. This confirmation step can be helpful in ensuring that the process moves forward only when the foundational elements are in place, potentially contributing to a more reliable overall transition.

In step 410, the RSP downloads the MVNO eSIM profile to the subscriber's pSIM. This step can be similar to the profile download process described in FIG. 2, but with the MVNO profile being downloaded instead of the MNO2 profile. The download process can involve securely transferring the new network profile to the SIM card, preparing it for activation on the MVNO network. This step can be performed while the device is still connected to the MNO1 network, leveraging the existing connection to facilitate the download.

Step 412 involves the Order Management system 208 executing the MVNO service provisioning subprocess. This step can encompass a range of activities to set up the subscriber's services on the MVNO network. It can include configuring network elements, setting up billing systems, and preparing any value-added services associated with the subscriber's plan. At step 414, a service provisioning process can provision service on the client device.

Step 416 activates the MVNO subscription. This activation can involve finalizing the configuration of the subscriber's account on the MVNO network and preparing it to handle live traffic. The activation process can include verifying that all provisioned services are operational and that the subscriber's profile is correctly set up in the MVNO's systems. This step can be helpful in ensuring that the subscriber's transition to the MVNO network will be as seamless as possible from a service perspective.

In step 418, the RSP switches the active SIM profile from MNO1 to MVNO. This step can be similar to the profile switch described in FIG. 2, but in the reverse direction. The switch can involve deactivating the MNO1 profile and activating the MVNO profile on the SIM card. This process can be designed to occur rapidly, potentially minimizing any service interruption. The profile switch can represent the point at which the device begins to use the MVNO network for its primary connectivity.

Step 420 involves the RSP performing a confirmation of the successful profile switch. This confirmation can be a verification step to ensure that the device has properly transitioned to using the MVNO profile. The confirmation process can involve checking various parameters to verify that the MVNO profile is active and functioning correctly. This step can help detect any issues that may have occurred during the profile switch, potentially allowing for prompt resolution if any problems are identified.

In step 422, the Local Number Portability (LNP) system initiates the port in process to the MVNO. This step can mark the beginning of the formal transfer of the subscriber's telephone number from MNO1 to the MVNO. The initiation of the port in process can involve sending requests to the relevant number portability databases and notifying MNO1 of the impending transfer. This step can be timed strategically within the overall process to help maintain service continuity.

Step 424 represents the LNP system completing the MVNO port in process. This completion can signify that the subscriber's telephone number has been successfully transferred to the MVNO's network. At this point, incoming calls and messages to the subscriber's number can begin to be routed through the MVNO's network infrastructure. The completion of the port in process can be a significant milestone in the network move, as it can finalize the transition of the subscriber's identity to the new network.

In step 426, the RSP deregisters the telephone number (TN) from the MNO1 eSIM and registers it to the MVNO eSIM. This step can involve updating various network databases and systems to reflect the new association of the telephone number with the MVNO profile. This deregistration and re-registration process can help ensure that all network elements are properly updated to handle the subscriber's traffic on the new network.

Step 428 involves the RSP setting the MVNO as the fallback profile. This configuration can help ensure that the device preferentially connects to the MVNO network in the future. Setting the fallback profile can be beneficial for maintaining consistent connectivity on the new network, potentially reducing the likelihood of unintended reversions to the previous network.

In step 430, the RSP performs a confirmation of the successful fallback profile change. This confirmation can serve as a verification that the device is properly configured to prioritize the MVNO network for future connections. This step can help ensure the long-term stability of the network move by verifying that the device will consistently use the new network.

Step 432 involves the RM or other component of the MVNO performing the deletion of the MNO1 profile from the SIM. This step can help clean up the SIM card by removing the now-unused MNO1 profile. Deleting the related profile can potentially free up memory on the SIM card and reduce the possibility of confusion or conflicts between multiple profiles.

Finally, in step 434, the RSP performs a confirmation of the successful deletion of the MNO1 profile. This confirmation can serve as a final check to ensure that the cleanup process has been completed successfully. Verifying the deletion of the related profile can help ensure that the device is fully transitioned to the MVNO network with no remnants of the previous configuration that could potentially cause issues in the future.

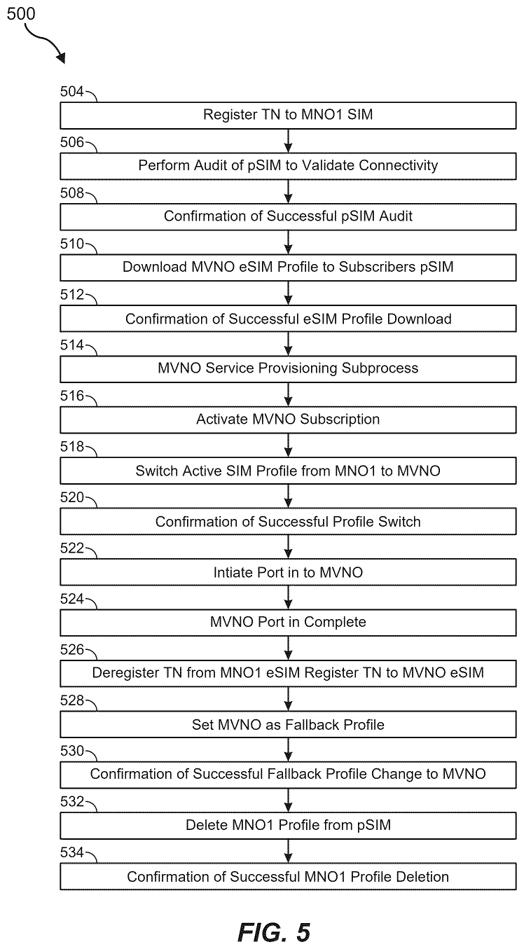

FIG. 5 illustrates a detailed flow diagram 500 of the network move process from MNO1 to MVNO, largely mirroring the steps shown in FIGS. 4A-4B. The process begins with step 504, where the telephone number is registered to the MNO1 SIM. In step 506, an audit of the physical SIM (pSIM) is performed to validate connectivity. Step 508 provides confirmation of a successful pSIM audit. Step 510 involves downloading the MVNO eSIM profile to the subscriber's pSIM. Step 512 confirms the successful eSIM profile download. Step 514 initiates the MVNO service provisioning subprocess, which can be implemented to prepare the necessary services on the MVNO network. This step can be beneficial in ensuring that all required services are ready before the actual switch occurs. Step 516 activates the MVNO subscription, followed by step 518 where the active SIM profile is switched from MNO1 to MVNO. Step 520 provides confirmation of the successful profile switch. In step 522, the port in to MVNO is initiated, followed by step 524 where the MVNO port in is completed. Step 526 involves deregistering the telephone number from the MNO1 eSIM and registering it to the MVNO eSIM. In step 528, MVNO is set as the fallback profile. Step 530 confirms the successful fallback profile change to MVNO. Finally, steps 532 and 534 involve deleting the MNO1 profile from the pSIM and confirming its successful deletion, respectively.

FIG. 6 shows a flow diagram for a method 600 relating to resynchronizing SIM state during a failed network switch. The method begins at start step 602. The method includes detecting an indeterminate response from a remote SIM provisioning platform at step 604. The method continues with attempting to reestablish connectivity with the client device at step 606, analyzing connection data and call detail records at step 608, and resynchronizing the remote SIM provisioning platform with the SIM at step 610. The method ends at stop step 612. In some examples, this process can help recover from failed network switches by determining the actual state of the SIM and taking appropriate action.

FIG. 7 illustrates a flow diagram for a method 700 relating to pre-allocation and management of multiple network profiles. The method begins at start step 702. The method includes preloading a SIM with encrypted profiles for multiple mobile network operators at step 704. The method continues with providing the preloaded SIM to a specific client at step 706, detecting a need for improved service or reduced resource consumption at step 708, and remotely switching the active profile without client input at step 710. The method ends at stop step 712. In some examples, this approach can enable flexible network switching capabilities while maintaining security and minimizing client involvement.

FIG. 8 presents a comprehensive test plan for validating the network move process. This diagram outlines a series of checks and tests designed to ensure that all aspects of the subscriber's service function correctly after transitioning to the new network. The tests cover a wide range of functionalities, from basic connectivity and voice services to more advanced features like Wi-Fi calling and value-added services. This thorough approach helps verify that the network move has been executed successfully and that the subscriber will experience seamless service on the new network.

The test plan begins with step 802, which involves confirming all device models that may be targeted for the network move. Step 804 requires running a functional test plan for each SIM brand. In step 806, the process confirms that APNs (Access Point Names) are working properly. Step 808 verifies that voicemail (VM) is functioning correctly, while step 810 confirms that Visual Voicemail (VVM) is working properly. Step 812 checks that Value Added Services (VAS) and other applications are operating as expected. Brand-specific applications are tested in step 814. Wi-Fi calling functionality is verified in step 816, and step 818 focuses on Wi-Fi E911. Step 820 involves running further testing through the Wi-Fi E911 registration page. Step 822 can involve running the VAS test plan. In step 824, speed tests are run on the MNO network to ensure proper data speeds.

Step 826 confirms brands and alpha tags are correct. Step 828 verifies that 611 customer care calls are working properly. The ability to SIM lock and unlock the device is confirmed in step 830. Step 832 checks that SIM and network authentication are functioning correctly. Wi-Fi Calling (WFC) and Mobile Hotspot (MHS) functionality are verified in step 834. Step 836 involves roaming tests for the network move. Finally, step 838 tests the network move process under bad coverage conditions.

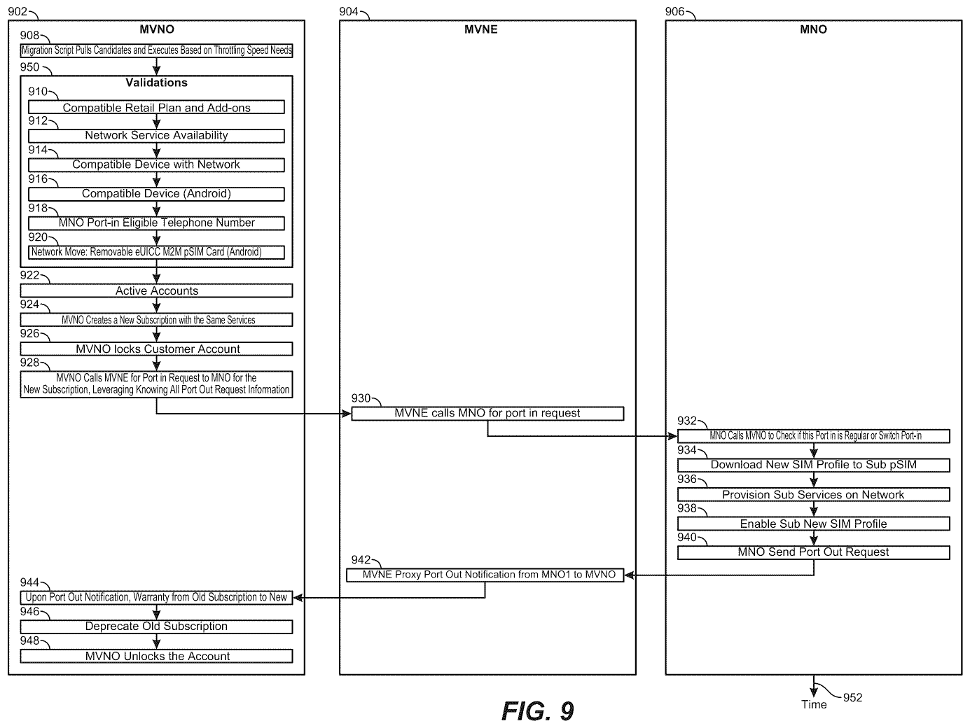

FIG. 9 shows a diagram 900 illustrating interactions between various systems during a network move process. In this example, MVNO 902 can include a retail wireless component of a mobile virtual network operator, for example, and as further discussed above. Mobile virtual network enabler MVNE 904 can include a mobile virtual network enabler that enables a mobile virtual network operator MVNO to provide telecommunication service. Mobile network operator MNO 906 can include a mobile network operator MNO that maintains network infrastructure and that partners with the mobile virtual network operator, consistent with the discussion above. A group of validations 950 can be performed to help ensure a successful network switch or move.

A first step can comprise performing a migration support script at step 908. The migration support script can be performed by MVNO 902. The migration support script can include a script that orchestrates and automates various steps in a network move process. In some examples, the migration script can be executed based on throttling speed needs, which can involve limiting the rate at which network move requests are processed, adjusting the data transfer speeds during the profile download, and/or controlling the speed at which the overall network move process is executed.

A compatible retail plan can be validated at step 910. Validating a compatible retail plan can include verifying that the subscriber's current plan is compatible with the target network. Network service availability can be validated at step 912. Validating network service availability can include confirming that the target network has coverage in the subscriber's location. A compatible device with the target network can be validated at step 914. Validating a compatible device with the network can include ensuring that the subscriber's device supports the target network's technology and frequency bands. A compatible device and subscriber identity module can be validated at step 916. Validating a compatible device and subscriber identity module can include confirming that the subscriber's device and subscriber identity module support the target network's subscriber identity module technology and provisioning protocols. In some embodiments, the client device can be an Android device and these embodiments may necessitate the usage of this mobile operating system. In other embodiments, including future embodiments, various mobile operating systems can be supported. An MNO port in eligible subscriber can be validated at step 918. Validating an MNO port in eligible subscriber can include verifying that the subscriber's telephone number can be ported to the target network. A network move eligible subscriber can be validated at step 920. Validating a network move eligible subscriber can include ensuring that the subscriber meets the criteria for a network move, which can include having an active account, being within the target network's coverage area, or having a compatible device and subscriber identity module. An active account can be validated at step 922. Validating an active account can include confirming that the subscriber's account is in good standing and eligible for service.

Retail wireless (MVNO) can create a new subscription at step 924. Creating a new subscription can include creating a new account and service plan for the subscriber on the target network. Retail wireless can lock a customer account at step 926. Locking a customer account can include restricting access to the subscriber's current account to prevent any changes during the network move process. Retail wireless can call MVNE 904 at step 928. Calling MVNE can include initiating the network move process by sending a request to the MVNE to begin provisioning the subscriber on the target network.

The MVNE 904 can then call the MNO 906 at step 930. Calling the MNO can comprise sending a request to the MNO to initiate the port in process for the subscriber's phone number. The MNO 906 can then call MVNO 902 at step 932. Calling MVNO can comprise confirming the port in request and obtaining any necessary information for the transfer. A new subscriber identity module (SIM) profile can be downloaded at step 934. Downloading a new subscriber identity module profile can comprise the MNO sending the new subscriber identity module profile to the subscriber's device over-the-air. Subscriber services can be provisioned at step 936. Provisioning subscriber services can comprise the MNO configuring its network to support the subscriber's new service plan and telephone number. A new subscriber identity module profile can be enabled at step 938. Enabling a new subscriber identity module profile can comprise activating the newly downloaded profile on the subscriber's device. A port out request can be sent by MNO at step 940. Sending a port out request can comprise the MNO initiating the transfer of the subscriber's phone number from the original network. The MVNE can send a proxy port out notification to the MVNO at step 942. Sending a proxy port out notification can comprise the MVNE informing the MVNO that the port out process has been initiated and is in progress.

Upon receiving the port out notification, MVNO 902 can perform one or more actions. Retail wireless 902 can update clone the warranty from the old written to the new subscription at step 944. Updating systems can include updating the subscriber's account status and billing information to reflect the change in network provider. Retail wireless can deprecate an old subscription at step 946. Deactivating an old subscription can include closing the subscriber's old account and terminating services on the original network. Retail wireless can unlock the account at step 948. Unlocking the account can include removing any restrictions that were placed on the subscriber's account during the network move process.

An indicator 952 can indicate the vertical direction of time, such that each step shown in FIG. 9 can be performed sequentially in time from top to bottom. The horizontal dimension of FIG. 9 can distinguish between which different entities or systems are involved in performing specific steps in the network move process, while the vertical dimension can represent the sequence of operations or steps within each entity's workflow.

FIG. 10 shows a diagram 1000 including a series of steps 1002-1008. The steps and associated sub-diagrams within diagram 1000 helped illustrate the process for switching the active profile on a corresponding subscriber identity module card. At step 1002, the new subscriber identity module profile that is specific to the target network mobile operator is downloaded to the physical subscriber identity module (pSIM) card. At step 1004, the subscriber's associated services from the source mobile network operator are provisioned on the target network of the target mobile network operator. At step 1006, the subscriber's new subscriber identity module profile is enabled. Lastly, at step 1008, the subscriber's telephone number is ported in to the target network of the target mobile network operator.

A sub-diagram 1010 graphically illustrates a series of transitions for a physical subscriber identity module card storing in memory a profile for a first mobile network operator (MNO1) and a second mobile operator that is maintained by the overall mobile virtual network operator (MVNO), as discussed above. As shown within sub-diagram 1010, the active profile on the subscriber identity module is switched from MNO1 to MVNO. Similarly, a sub-diagram 1012 illustrates how an arbitrary telephone number associated with the subscriber may be transferred, through port in a port out procedure, from MNO1 to MVNO.

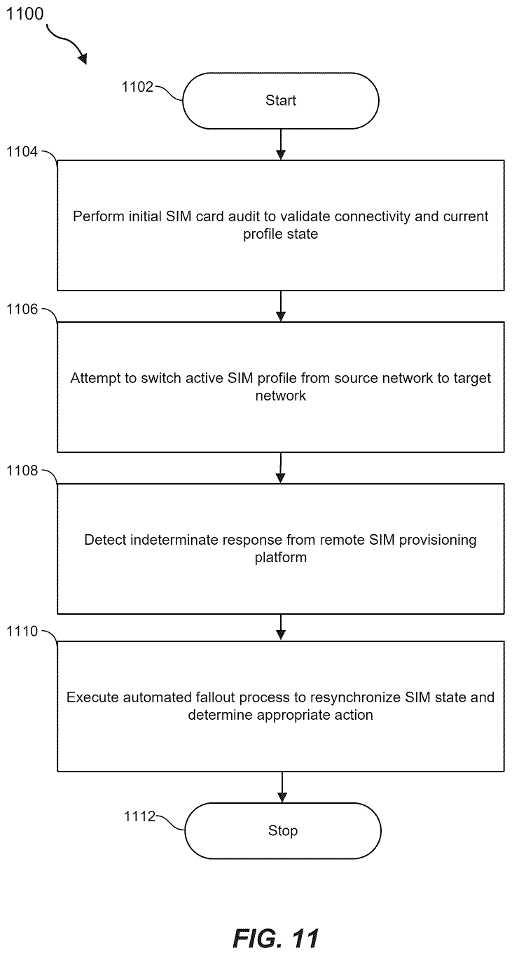

FIG. 11 illustrates a flow diagram for a method 1100 relating to SIM profile auditing and error handling during a network move process. The method begins at start step 1102. The method includes performing an initial SIM card audit to validate connectivity and current profile state at step 1104. The method further includes attempting to switch the active SIM profile from the source network to the target network at step 1106. The method then includes detecting an indeterminate response from the remote SIM provisioning platform at step 1108. Finally, the method includes executing an automated fallout process to resynchronize the SIM state and determine appropriate action at step 1110. The method ends at stop step 1112.

The method 1100 illustrated in FIG. 11 addresses the challenges associated with managing network moves for devices “in the wild.” These devices may be in various states of connectivity, battery life, or usage, making the network move process unpredictable. The initial SIM card audit performed in step 1104 is baseline for establishing a baseline understanding of the device's current state. This audit not only validates connectivity but also reports back detailed information about the SIM card's current profile and installed profiles, providing a comprehensive snapshot of the device's network status.

Step 1106, which involves attempting to switch the active SIM profile. This step is where a significant portion of failures can occur. The switch attempt can result in three possible outcomes: success, definitive failure, or an indeterminate state. The method 1100 specifically addresses the challenging scenario of an indeterminate state, as detected in step 1108. This indeterminate state occurs when the remote SIM provisioning (RSP) platform knows that the SIM card failed to switch profiles successfully, but the SIM card did not report its current state, leaving the system uncertain about which network profile is actually active.

To resolve this uncertainty, the method employs an automated fallout process in step 1110. This process involves a series of automated steps to resynchronize the state between the RSP platform and the SIM card. These steps may include attempts to reestablish connectivity with the device, analyzing connection data, or examining call detail record (CDR) data associated with the client device. The goal is to determine definitively whether the SIM is using the source network profile or has successfully switched to the target network profile. This information can be helpful for deciding whether to proceed with the network move or to revert the process, which can help to ensure that the subscriber's service is not jeopardized by incomplete or incorrect profile switching.

By way of background, the Remote SIM Provisioning (RSP) platform can communicate with SIM cards using industry-standard protocols defined by the 3rd Generation Partnership Project (3GPP). These specifications, particularly those related to embedded Universal Integrated Circuit Card (eUICC) and eSIM management, outline the standardized methods for remote management of SIM profiles. The GSMA has also published specifications for Remote SIM Provisioning, which build upon the 3GPP standards. These protocols define the secure communication channels and commands used to perform various operations on the SIM card, such as downloading new profiles, enabling or disabling profiles, and querying the current state of the SIM. The RSP platform uses these standardized interfaces to send commands to the SIM card, including profile management commands, audit requests, and status queries. These commands are typically sent over-the-air using cellular data connections, allowing for remote management of SIM profiles without physical access to the device. The use of these industry-standard protocols ensures interoperability between different vendors'RSP platforms and SIM cards, enabling mobile network operators and mobile virtual network operators to manage profiles across a diverse ecosystem of devices and SIM manufacturers.

Illustrative examples of such protocols include the GSMA's Remote SIM Provisioning specifications such as SGP.21, which covers the RSP Architecture, and SGP.22, which defines the Technical Specification for Remote SIM Provisioning. From the 3GPP, several specifications may be relevant. TS 31.102 defines the Characteristics of the Universal Subscriber Identity Module (USIM) application. TS 31.111 covers the Universal Subscriber Identity Module (USIM) Application Toolkit (USAT). TS 31.130 specifies the (U)SIM Application Programming Interface (API) for Java Card. Additionally, ETSI TS 102 221 defines the physical and logical characteristics of the UICC-Terminal interface. These specifications can be used for SIM card and RSP communications, though the specific set used may vary depending on the implementation details of the system being described.

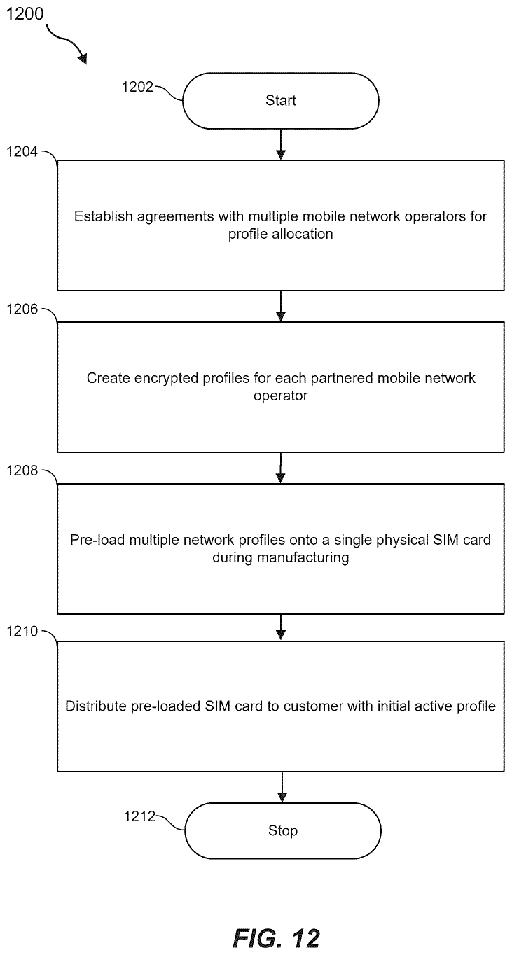

FIG. 12 shows a flow diagram for a method 1200 relating to pre-allocation of multiple network profiles on a single SIM card. The method begins at start step 1202. The method includes establishing agreements with multiple mobile network operators for profile allocation at step 1204. The method further includes creating encrypted profiles for each partnered mobile network operator at step 1206. The method then includes pre-loading multiple network profiles onto a single physical SIM card during manufacturing at step 1208. Finally, the method includes distributing the pre-loaded SIM card to a customer with an initial active profile at step 1210. The method ends at stop step 1212.

The method 1200 shown in FIG. 12 represents an innovative approach to streamlining future network moves by pre-allocating multiple network profiles on a single SIM card. This method begins with establishing agreements with multiple mobile network operators for profile allocation in step 1204. These agreements can form the foundation for a flexible, multi-operator SIM card that can seamlessly transition between networks without requiring physical SIM replacement or complex reconfiguration processes.

Step 1206 involves creating encrypted profiles for each partnered mobile network operator. This step is helpful for maintaining the security and integrity of each operator's network access credentials. The encryption process typically utilizes shared secrets specific to each mobile network operator, ensuring that only authorized devices and systems can access and utilize these profiles. This level of security is essential for maintaining the trust and cooperation of partner networks in this multi-profile SIM arrangement.

The pre-loading of multiple network profiles onto a single physical SIM card during manufacturing, as shown in step 1208, is one innovation in this method. This approach allows for rapid switching between networks when needed, potentially reducing the time and resources required for network switches. By having multiple profiles pre-loaded, the system can avoid the need for over-the-air profile downloads during a network move, which can be prone to failures due to connectivity issues or other factors. The final step 1210, distributing the pre-loaded SIM card to a customer with an initial active profile, sets the stage for future seamless network transitions, enhancing the flexibility and responsiveness of mobile virtual network operator services.

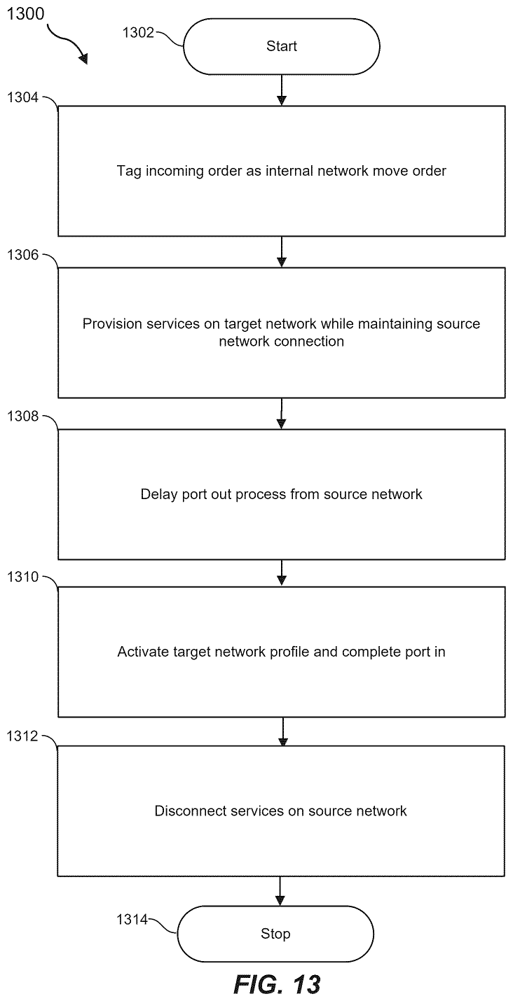

FIG. 13 shows a flow diagram for a method 1300 relating to orchestrating an internal network move order. The method begins at start step 1302. The method includes tagging an incoming order as an internal network move order at step 1304. The method further includes provisioning services on the target network while maintaining the source network connection at step 1306. The method then includes delaying the port out process from the source network at step 1308. The method continues with activating the target network profile and completing the port in at step 1310. Finally, the method includes disconnecting services on the source network at step 1312. The method ends at stop step 1314.

The method 1300 illustrated in FIG. 13 outlines a sophisticated process for orchestrating an internal network move order, designed to minimize service interruption and maximize efficiency. The process begins with tagging an incoming order as an internal network move order in step 1304. This tagging is helpful for differentiating these special cases from standard activations or ports, allowing the system to apply the appropriate workflows and avoid unnecessary steps that might disrupt service continuity.

The tag used in the network move process can be implemented as an order header characteristic within the payload of the order. It can be thought of as a string value or identifier that is added to the order to distinguish it as a network move order. This tag is specifically designed to have meaning only to the wholesale mobile network operator order management platform. When this platform receives an order with the network move tag, it recognizes that although the order may appear similar to a standard port in activation, it requires a different orchestration process. The tag allows the system to limit the exposure of the network move process to only the necessary systems, as intermediary systems that the order passes through may not need to be aware of its special nature. This tagging mechanism enables the order to be processed through various systems as if it were a normal port in activation until it reaches the specific components that need to handle it differently for the network move process.

In various examples, the payload can be formatted according to the Simple Object Access Protocol (SOAP). Nevertheless, in additional or alternative examples, various messaging protocols can be employed by mobile virtual network operators to facilitate communication between different systems in the network move process. While SOAP can be a helpful choice, other protocols such as REST (Representational State Transfer), gRPC (gRPC Remote Procedure Call), or even custom-built messaging systems could potentially be used. One commonality among these protocols is their ability to structure and transmit data between disparate systems in a standardized format. These protocols typically support the inclusion of metadata or headers, which allows for the addition of custom identifiers or tags to messages. This capability is helpful for implementing the tagging mechanism used in network move orders. Regardless of the specific protocol chosen, the fundamental requirements include the ability to encapsulate complex data structures, support for adding custom attributes or headers to messages, and mechanisms for secure and reliable transmission of data across networks. The choice of protocol may depend on factors such as existing infrastructure, performance requirements, and compatibility with partner systems. What remains consistent across these options is the need for a structured way to represent orders, the ability to include identifying information (such as the network move tag), and support for the various data elements required in the network move process.

Step 1306, which involves provisioning services on the target network while maintaining the source network connection, is one innovation in this process. This dual-network provisioning allows for a seamless transition by ensuring that the subscriber's services are fully set up on the new network before any disconnection from the related network occurs. This approach significantly reduces the risk of service interruption that typically occurs in traditional network switching processes where disconnection from the related network precedes activation on the new network.

The deliberate delay of the port out process from the source network, as shown in step 1308, is another critical aspect of this method. This delay allows for careful orchestration of the transition, ensuring that all necessary preparations on the target network are complete before initiating the number transfer. Steps 1310 and 1312, which involve activating the target network profile, completing the port in, and finally disconnecting services on the source network, are sequenced to maintain continuous service. This ordering of operations allows for a “hot” switch where the subscriber potentially experiences no noticeable interruption in service, as they are effectively active on both networks during the transition period before the final disconnection from the source network.

FIG. 14 presents a flow diagram for a method 1400 relating to predictive network move initiation. The method begins at start step 1402. The method includes analyzing historical network performance and subscriber movement data at step 1404. The method continues with predicting future network congestion and coverage issues at step 1406, identifying subscribers for proactive network moves at step 1408, initiating network moves for affected subscribers at step 1410, and monitoring outcomes and refining prediction models at step 1412. The method ends at stop step 1414. In some examples, this predictive approach can help maintain service quality by anticipating and addressing potential issues before they impact subscribers, potentially optimizing network resources and improving overall subscriber satisfaction.

FIG. 15 illustrates a comparison between related and new network switching methods, providing a visual representation of the process improvements described in FIG. 1A. The left side depicts the related method, showing the cumbersome and time-consuming nature of traditional network switches. In the first panel on the left side, a person 1500 is shown in a living room setting, seated on a sofa while holding a smartphone 1502. The smartphone's screen displays a prominent Wi-Fi symbol 1504 along with a “Connecting . . . ” message, indicating the reliance on Wi-Fi connectivity for the switching process. A router 1506 is visible nearby. The person's expression suggests slight impatience, highlighting the user's involvement and potential frustration with the process.

The second panel on the left side focuses on the smartphone screen 1502, which now displays a PIN entry interface 1508. The person's fingers 1510 are shown inputting a code, emphasizing the manual intervention required in the related method. This step represents the need for user authentication and authorization in the related switching process, which can be prone to errors and delays. The third panel on the left side further illustrates the time-consuming nature of the related method. The person 1500 is now standing, looking at their watch with a noticeably frustrated expression. The smartphone 1502 is placed on a table, its screen showing a progress bar 1512 at about 50% completion, with text reading “Switching networks . . . ”. This visual cue effectively conveys the lengthy duration and lack of transparency in the related switching process.

In contrast, the right side of FIG. 15 illustrates one inventive solution, which aligns with the process described in FIG. 1A. The first panel on this side presents a cafe scene, where the same person 1500 is seated at a table, casually using their smartphone 1502. Their relaxed demeanor suggests they are unaware of any network changes occurring, highlighting the invisible nature of the switching process. In the background, two different cell towers 1514 and 1516 are depicted, representing different mobile network operators and illustrating the behind-the-scenes transition between networks.

The second panel on the right side provides a close-up view of the smartphone screen 1502, showing normal use such as a social media app or web browsing. This image emphasizes that the user's experience remains uninterrupted during the network switch. In a corner of the screen, a small network icon 1518 is shown smoothly transitioning from one carrier name to another, almost imperceptibly. This subtle detail illustrates the seamless nature of the new switching process, aligning with the method described in FIG. 1A where the switch is performed entirely through cellular connectivity without user intervention. In other examples, the transition may be entirely invisible with no change in the interface at all.

The final panel on the right side shows the person 1500 walking away from the cafe, still engrossed in their phone 1502. Their contented expression indicates they remain completely unaware of the network switch that has occurred. In the background, the two cell towers 1514 and 1516 are still visible, reinforcing the concept of transition between networks. This panel effectively demonstrates the end result of the process outlined in FIG. 1A, where the network switch can be completed without any noticeable impact on the user's experience or service continuity.

FIG. 16 presents a multi-panel illustration that provides a visual representation of the invisible network switch process in some examples, expanding on the concepts introduced in FIG. 1A. This figure offers a look at how the mobile virtual network operator (MVNO) can orchestrate the network switch without user intervention. The first panel of FIG. 16 depicts the interior of an MVNO office, providing context for where the network switch process is initiated and managed. The room is shown with several employees at workstations, representing the team responsible for overseeing and implementing network switches. The computers can correspond to MVNO system 1520. One of the screens prominently displays a map with numerous customer locations and network coverage areas. This visual representation emphasizes the MVNO's ability to monitor and manage a large number of subscribers across various network infrastructures, setting the stage for the network switch process.

In the second panel, we see a close-up of a server screen 1522 that is part of the MVNO system. The screen displays “Initiate invisible network switch” with a list of subscriber IDs below it. One ID is highlighted, indicating the selection of a specific customer for the switch. This panel illustrates the precise and targeted nature of the network switch process, aligning with the method described in FIG. 1A where the MVNO receives an indication to perform a network switch for a specific client device. The visual representation of selecting a single subscriber ID from a list emphasizes the individualized approach to network switching, where each transition can be managed on a per-customer basis. In other examples, the network switch process can be performed automatically, in the background, or in a batch process.

The third panel of FIG. 16 presents a split screen showing two cell towers side by side. One tower is labeled as “Source MNO” 1514 and the other as “Target MNO” 1516. Data packets 1524 are depicted moving from the source tower to the target tower, representing the behind-the-scenes transition of the subscriber's service. This visual metaphor effectively conveys the concept of data and service migration from one network to another, which is one aspect of the network switch process outlined in FIG. 1A. The flow of data packets between the towers illustrates the continuous connectivity maintained during the switch, a feature that distinguishes this process from traditional switching methods.

The fourth and final panel of FIG. 16 provides a detailed close-up of a smartphone's SIM card slot 1526. The SIM card 1528 is shown partially exposed, with tiny lights or indicators on it to represent the changing profile. One profile is labeled as “Source MNO” and is shown fading, while another labeled “Target MNO” is brightening. This detailed view illustrates the core mechanism of the network switch at the device level, where the active profile on the SIM card is changed from the source network to the target network. This aligns with the process described in FIG. 1A, where the MVNO performs the network switch by changing the home network of the client device. The visual representation of fading and brightening profiles effectively conveys the transition between networks, emphasizing the seamless nature of the switch from the user's perspective.

FIG. 17 displays a comprehensive box diagram illustrating the process flow of the invisible network switch in some examples, providing a more detailed breakdown of the steps outlined in FIG. 1A. The diagram begins with box 1530, labeled “MVNO initiates network switch”. This corresponds to the first step in FIG. 1A, where the MVNO receives an indication to perform a network switch. The visual representation of this step as the starting point of the flowchart emphasizes the MVNO's role in initiating and controlling the switching process.

The next box, 1532, represents “Download target MNO profile to SIM”, which is a preparatory step in the switch process. This step illustrates the technical preparation required for the switch, where the new network profile is transferred to the user's device before any active changes are made. This is followed by box 1534, “Provision services on target MNO,” aligning with the action in FIG. 1A where the MVNO begins to set up the client's service on the new network. The inclusion of this step in the diagram highlights the importance of ensuring that all necessary services are ready on the new network before the switch is completed.

Box 1536, “Activate target MNO profile”, represents the point at which the new network profile becomes operational on the client's device. This step visualizes the moment when the device transitions from using the old profile to the new one. The next box, 1538, “Delay port in procedure”, is larger and highlighted to emphasize its importance in the process. This step is central to maintaining service continuity and corresponds to the MVNO's ability to control the timing of the switch, as mentioned in FIG. 1A. The visual emphasis on this step underscores its role in distinguishing this switching method from traditional approaches.

The diagram continues with box 1540, “Complete port in”, which represents the finalization of the number transfer to the new network. The last step, shown in box 1542, is “Deactivate source MNO profile”, indicating the completion of the switch process as the old network profile is disabled. These final steps illustrate the sequential nature of the switch, where the new network is fully operational before the old network is disconnected. A callout box 1544 near the “Delay port in procedure” step explains: “Delaying port in can ensure continuous service during transition”. This annotation highlights the significance of this step in maintaining uninterrupted service for the client, which can be a feature of the method described in FIG. 1A.

FIG. 18 presents a detailed multi-panel illustration of the port out interceptor process in some examples, expanding on the concepts introduced in FIG. 1B. This figure provides a visual representation of how the MVNO maintains control over the switching process when moving a subscriber from its own network to another mobile network operator (MNO). The first panel of FIG. 18 depicts the interior of an MVNO network operations center. This large room is shown with multiple workstations, monitors, and servers, representing the sophisticated infrastructure required to manage network operations. The MVNO system 1800 is prominently displayed, consisting of a complex setup of servers and large screens showing network diagrams and customer data. Several technicians 1802 are visible working at their stations, emphasizing the human oversight involved in the process. One of the main screens displays a map with customer locations and their network status, illustrating the MVNO's ability to monitor and manage its subscriber base across different network infrastructures. This comprehensive view sets the stage for the process of intercepting and managing port out requests during a network switch.

The second panel of FIG. 18 focuses on a main control screen 1804 within the MVNO system. This screen displays “Initiate Network Switch to MNO2” with a list of subscriber IDs below it, mirroring the initial step described in FIG. 1B where the MVNO receives an indication to perform a network switch. One subscriber ID is highlighted, indicating the selection of a specific customer for the switch. Next to this, a button labeled “Activate Port Out Interceptor” 1806 is prominently displayed. A technician's hand 1808 is shown reaching towards this button, emphasizing the deliberate and controlled nature of this action. This visual cue represents the MVNO's proactive step in managing the port out process, which can be one aspect of the method described in FIG. 1B where the MVNO is configured to designedly delay the disconnection of cellular connectivity.

The third panel of FIG. 18 presents a split screen showing two distinct network infrastructures. On the left side, labeled “MVNO” 1810, we see the characteristic cell towers and equipment of the MVNO's network. On the right side, labeled “MNO2” 1812, we see a similar but distinct set of towers and equipment representing the target network. Between these two networks, a customer's smartphone 1814 is depicted with animated signals connecting to both networks. This visual representation illustrates the transition phase of the network switch, where the customer's device maintains connectivity to both networks simultaneously. This aligns with the concept introduced in FIG. 1B, where the MVNO maintains cellular connectivity with the client device on both the source and target networks during the switch process.

The fourth and final panel of FIG. 18 provides a close-up view of a server rack labeled “Port Out Interceptor” 1816. This server is shown with lights activating, and a small screen displays “Interceptor Active” 1818. Around this server, dotted lines or arrows are drawn pointing to both the MVNO and MNO2 sections of the network diagram, illustrating its intermediary role in the switching process. This visual representation emphasizes the critical function of the port out interceptor in managing the transition between networks. It visually demonstrates how the MVNO can intercept and control the port out process, allowing for the delayed disconnection described in FIG. 1B, which can be helpful to maintaining service continuity during the switch.

FIG. 19 provides a comprehensive illustration that delves deeper into the network switching process in some examples, offering a more detailed view of the concepts introduced in FIGS. 1A and 1B. This figure effectively visualizes the complex interactions between different components of the network infrastructure during a switch, with a particular focus on the role of the port out interceptor. The left side of the illustration showcases the MVNO infrastructure 1820, depicted as a collection of servers and network equipment. Among these, the “Port Out Interceptor” 1816 is prominently featured, emphasizing its role in managing the switching process

At the center of FIG. 19 is a customer's smartphone 1814, serving as the focal point of the network switch process. An enlarged view of the SIM card 1824 within the phone is displayed, showing multiple profiles. These profiles are labeled to indicate the MVNO profile and the MNO2 profile, visually representing the dual-profile capability that enables seamless switching between networks. This detailed view of the SIM card aligns with the process described in FIG. 1A and FIG. 1B, where the switch can involve changing the active profile on the client's device. The right side of the illustration depicts the MNO2 infrastructure 1826, mirroring the MVNO side but with distinct characteristics to represent the target network.

Between the MVNO and MNO2 infrastructures, the port out interceptor 1816 is prominently displayed as a shield-like structure. This visual metaphor effectively conveys the interceptor's role in protecting the continuity of the customer's service during the switch. Arrows representing the normal data flow are shown, with some arrows being intercepted and redirected by the interceptor. This graphical representation illustrates how the interceptor manages and controls the flow of information during the switching process, aligning with the concept introduced in FIG. 1B where the MVNO designedly delays the disconnection of cellular connectivity.

A zoomed-in bubble 1828 provides a detailed view of the interceptor in action, showing how it receives a disconnect request, modifies it, and sends an approval without actual disconnection. This specific illustration helps to clarify the technical process behind the MVNO's ability to maintain service continuity during the switch, as described in FIG. 1B. At the bottom of FIG. 19, a small timeline is included showing the sequence of events in the switching process: 1) switch initiation, 2) profile download, 3) interception, 4) new network activation, and 5) delayed disconnection.

FIG. 20 presents a detailed box diagram that provides a step-by-step visualization of the interceptor process in some examples, expanding on the concepts introduced in FIG. 1B and illustrated in FIGS. 18 and 19. The diagram begins with box 1830, labeled “Receive network switch indication”. This corresponds to the initial step in FIG. 1B, where the MVNO receives an indication to perform a network switch. The next box, 1832, represents “Activate Port Out Interceptor,” which is a helpful preparatory step within this interception process. This step can help to ensure that the MVNO is ready to manage and control the port out process as described in FIG. 1B.

The diagram continues with box 1834, “Download MNO2 profile”, representing the preparation of the client's device for the new network. This is followed by box 1836, “Provision services on MNO2”, aligning with the action in FIG. 1B where the MVNO begins to set up the client's service on the target network. Boxes 1838 and 1840, “Intercept port out request” and “Approve port out without disconnecting” respectively, are larger and highlighted within this figure to emphasize their role in the process. These steps can help enable the MVNO to maintain control over the switching process and ensure service continuity, as described in connection with FIG. 1B.

The final steps of the process are represented by boxes 1842, “Complete switch to MNO2”, and 1844, “Disconnect from MVNO”. These steps illustrate the completion of the network switch and the final disconnection from the original network, which can occur after ensuring successful connection to the new network. This sequence aligns with the method described in FIG. 1B, where the MVNO delays disconnection until after establishing connectivity with the target network. A callout box 1846 near boxes 1838 and 1840 explains: “Interceptor maintains connectivity during transition”. To be clear, although the delaying feature is highlighted in FIG. 1B and FIG. 20, it can apply to all of the embodiments in this application.

FIG. 21 presents a detailed multi-panel illustration that visualizes the network switch audit process in some examples, expanding on the concepts introduced in FIG. 1C. This figure provides a comprehensive view of how the mobile virtual network operator (MVNO) detects, analyzes, and responds to failed network switch attempts. The first panel of FIG. 21 depicts the interior of an MVNO network operations center, similar to the setting in FIG. 18. The MVNO system 2100 is prominently displayed, showing a sophisticated setup of servers and large screens dedicated to monitoring network switch operations. Several technicians 2102 are visible working at their stations, emphasizing the human oversight involved in the audit process. One of the main screens displays “Network Switch Audit Initiated”, setting the stage for the detailed examination of a failed switch attempt. Additionally, or alternatively, in other examples the audit procedure may be automated, performed in the background, performed autonomously without manual intervention by an agent, and/or performed in a batch process.

The second panel of FIG. 21 focuses on a main control screen 2104 within the MVNO system. This screen displays a list of subscriber IDs, with one ID highlighted, indicating a failed switch attempt. Next to this, a button labeled “Begin Comprehensive Audit” 2106 is prominently displayed. A technician's hand 2108 is shown reaching towards this button, emphasizing the deliberate initiation of the audit process. This visual cue represents the MVNO's proactive approach to identifying and addressing switch failures, aligning with the step in FIG. 1C where the MVNO detects that the attempted network switch failed.

The third panel of FIG. 21 presents a split screen showing a smartphone 2110 on one side and a detailed view of a SIM card 2112 on the other. The smartphone screen displays a network error message, visually representing the failed switch attempt from the user's perspective. On the SIM card view, multiple profiles 2114 and 2116 are illustrated, with one profile flickering or showing an error state. This detailed representation helps to visualize the technical aspects of the switch failure, particularly the indeterminate state of the SIM card that may occur during a failed switch attempt, as described in FIG. 1C. The split screen effectively contrasts the user-facing issue with the underlying technical problem, highlighting the complexity of network switch failures.

The fourth and final panel of FIG. 21 provides a close-up view of an audit results screen 2118. This screen displays “Switch Attempt Failed-Cause: Indeterminate SIM State”, corresponding to the detection step outlined in FIG. 1C. Below this, a list of potential remedial actions 2120 is shown, with one option highlighted: “Initiate Profile Resynchronization.” This panel illustrates the outcome of the audit process and the transition to the remedial action phase described in FIG. 1C. It effectively demonstrates how the MVNO system analyzes the failed switch attempt and proposes solutions, setting the stage for the subsequent remedial actions to address the issue and potentially complete the network switch or revert to the original network configuration.

FIG. 22 offers a comprehensive illustration that delves deeper into the audit process in some examples, providing a more detailed view of the concepts introduced in FIG. 1C. This figure effectively visualizes the complex interactions between different components of the network infrastructure during an audit, with a particular focus on the various states and checks involved in diagnosing a failed network switch. The left side of the illustration showcases the MVNO system 2100 with a prominent “Remote SIM Provisioning (RSP) Platform” 2122. Data packets 2124 are shown flowing from this platform towards the center of the illustration, representing the continuous stream of information being processed and analyzed during the audit process. This visual representation aligns with the audit step described in FIG. 1C, where the MVNO can perform a comprehensive examination of the attempted network switch.

At the center of FIG. 22 is a customer's smartphone 2110 with an enlarged view of the SIM card 2112. The SIM card is shown with multiple profiles 2114 and 2116, with one profile in an error state. This detailed view of the SIM card corresponds to the scenario in FIG. 1C where the MVNO detects an issue with the network switch. Above the phone, a thought bubble 2126 represents the SIM's current state, with question marks and conflicting network icons to indicate the indeterminate state. This visual metaphor effectively conveys the uncertainty surrounding the SIM's status after a failed switch attempt, which can be one aspect of the scenario described in FIG. 1C.

The right side of FIG. 22 displays various network states represented as separate bubbles: “Profile Download Failed” 2128, “Indeterminate State” 2130, “Partial Activation” 2132, and “Connectivity Lost” 2134. These bubbles illustrate the range of potential issues that the audit process might uncover, providing a visual representation of the comprehensive nature of the audit described in FIG. 1C. Between the MVNO system and the phone, the audit process 2136 is depicted as a series of scanning beams or probes, each labeled with a specific check: “SIM Connectivity Check” 2138, “Profile State Analysis” 2140, and “Network Registration Verification” 2142. These visual elements represent various aspects of the audit process, aligning with the comprehensive examination described in FIG. 1C.

At the bottom of FIG. 22, a small timeline is included showing the sequence of events in the audit process: 1) switch attempt, 2) failure detection, 3) audit initiation, 4) state analysis, and 5) remedial action selection. This timeline provides a clear, chronological overview of the process, tying together the various elements illustrated in the figure and relating them back to the steps outlined in FIG. 1C.

FIG. 23 presents a detailed box diagram that provides a step-by-step visualization of the audit and remediation process in some examples, expanding on the concepts introduced in FIG. 1C and illustrated in FIGS. 21 and 22. This figure uses a flowchart format with rectangular boxes for each step, connected by arrows to show the process flow, offering a clear and structured representation of one embodiment of the audit and remediation procedure. The diagram begins with box 2144, labeled “Attempt network switch”, corresponding to the initial step in FIG. 1C where the MVNO performs an attempted network switch. This is followed by box 2146, “Detect switch failure”, which aligns with the detection step described in FIG. 1C where the MVNO identifies that the attempted switch has failed.

The next step in the diagram, represented by box 2146, is “Initiate audit process”. This corresponds to the MVNO's response to detecting the switch failure, as outlined in FIG. 1C. The subsequent boxes, 2150 “Check SIM connectivity” and 2152 “Analyze SIM profile state”, are larger and highlighted to emphasize their critical role in the audit process. These steps represent the core of the audit procedure, enabling the MVNO to gather detailed information about the state of the SIM card and the nature of the switch failure. This aligns with the comprehensive audit described in FIG. 1C, where the MVNO can examine various aspects of the failed switch attempt.

The diagram continues with box 2154, “Determine failure cause”, representing the outcome of the audit process. This step bridges the gap between the audit and the remediation phases described in FIG. 1C. Following this, the diagram shows a decision diamond 2162, which leads to either box 2156 “Select remedial action” (if a cause is determined) or loops back to box 2146 “Initiate audit process” (if the cause remains unknown). This decision point illustrates the potential need for repeated audits in complex failure scenarios. The final steps of the process are represented by boxes 2158 “Implement remedial action” and 2160 “Verify resolution”. These steps correspond to the remedial action phase described in FIG. 1C, where the MVNO can take steps to address the identified issues and confirm that the problem has been resolved.

Before proceeding to the discussion of FIG. 24, the following provides a comprehensive overview of different remedial actions that can be performed in response to the audit and consistent with FIG. 1C. The audit process in a network switch scenario can result in three distinct outcomes: a successful profile switch, a definitive failure, or an indeterminate state. Each of these outcomes indicates different remedial actions to ensure the continuity of service for the subscriber and the successful completion of the network switch when possible.

In the case of a successful profile switch, where the audit can confirm that the SIM card has successfully transitioned to the target network profile, the remedial actions are primarily focused on verifying and optimizing the new connection. These actions may include conducting a thorough test of all provisioned services on the new network to ensure they are functioning as expected. This could involve making test calls, sending text messages, and performing data connection speed tests. If any discrepancies are found in the service quality or availability, the mobile virtual network operator (MVNO) may need to coordinate with the target mobile network operator (MNO) to fine-tune network settings or resolve any provisioning issues. Additionally, the MVNO might implement a temporary dual-routing solution, where incoming calls and messages are routed to both the old and new networks for a short period, ensuring no communications are missed during the transition.

When the audit results in a definitive failure, indicating that the SIM card was unable to switch profiles and remains on the source network, a different set of remedial actions may be performed. The first step in this scenario can be to revert any partial changes made during the switch attempt, ensuring that the subscriber's service on the original network remains unaffected. This may involve resetting the SIM card to its original state and reconfirming the activation of all services on the source network. Following this, the MVNO can initiate a comprehensive diagnostic process to identify the root cause of the failure. This could include analyzing logs from the remote SIM provisioning platform, examining network traffic data, and potentially running remote diagnostics on the subscriber's device.

Based on the results of this diagnostic process, the MVNO might attempt to resolve the issue through various means. For instance, if the failure was due to a corrupted profile download, the MVNO could attempt to re-download the target MNO's profile to the SIM card. If the issue stems from incompatibility between the device and the new network, the MVNO might need to work with the target MNO to adjust network settings or update the profile configuration. In some cases, especially if the problem is determined to be hardware-related, the MVNO might need to arrange for a replacement SIM card to be sent to the subscriber.

One complex scenario can occur when the audit results in an indeterminate state, where the remote SIM provisioning platform may be unable to confirm the current state of the SIM card. This situation can indicate a careful and systematic approach to remediation. The first step can be to attempt to reestablish communication with the SIM card. This might involve sending a series of diagnostic commands to the card, trying to connect through alternative cellular bands or technologies, or even requesting that the subscriber perform certain actions like restarting their device.

If communication is reestablished, the MVNO can then seek to determine the actual state of the SIM card. This could involve a process of profile resynchronization, where the SIM card is instructed to report its current active profile and the list of all installed profiles. Based on this information, the MVNO can then take appropriate action. If the SIM is found to be using the target network profile despite the initial uncertainty, the MVNO might proceed with completing the switch process, including finalizing any backend provisioning and porting processes.

On the other hand, if the SIM is found to still be on the source network profile, the MVNO might choose to retry the profile switch. This second attempt would likely involve a modified approach based on the information gathered during the audit and resynchronization process. For example, if the initial failure was due to network congestion, the MVNO might wait for a period of lower network activity before reattempting the switch.

In some cases of indeterminate state, more drastic measures may be helpful initiating a complete reset of the eSIM, effectively wiping all profiles and starting the provisioning process from scratch. While this approach ensures a clean slate, it can also indicate careful management to minimize service disruption for the subscriber. The MVNO would need to have systems in place to quickly re-provision all necessary profiles and restore the subscriber's services.

Another potential remedial action in complex cases is to provision an entirely new eSIM profile. This approach bypasses potential issues with the existing profiles on the SIM card by creating a fresh profile for the target network. However, this method can benefit from careful coordination to ensure that the new profile is correctly associated with the subscriber's account and that all services are properly configured.

Throughout all these remedial actions, maintaining clear communication with the subscriber is paramount. While the network switch process is designed to be invisible to the user, in cases where remedial actions are necessary, the MVNO may need to inform the subscriber of potential brief service interruptions or request their cooperation (such as restarting their device). This communication should be carefully managed to maintain subscriber confidence while resolving the switching issues.

In some cases, the remedial actions might also involve coordination with the target MNO. This could be necessary if the audit process reveals issues on the network side rather than with the SIM card or device. Such actions might include working with the MNO to adjust network settings, resolve routing issues, or address any problems with the number porting process.

Finally, regardless of the specific remedial actions taken, it can be helpful for the MVNO to log and analyze all audit results and remedial actions. This data can be used to refine and improve the network switching process over time, potentially identifying common issues or patterns that can be proactively addressed in future switch attempts. This continuous improvement process helps to increase the overall success rate of network switches and minimize the need for remedial actions in the future.

FIG. 24 presents a detailed multi-panel illustration that visualizes the SIM profile pre-allocation process in some examples, expanding on the concepts introduced in FIG. 1D. This figure provides a comprehensive view of how the mobile virtual network operator (MVNO) can prepare SIM cards with multiple network profiles, enabling seamless future network switches. The first panel of FIG. 24 depicts the interior of an MVNO headquarters, showcasing a large room with workstations, servers, and a prominent wall display showing network maps of multiple mobile network operators (MNOs). The MVNO system 2400 is labeled prominently, emphasizing its central role in managing the pre-allocation process. This panel sets the stage for the complex ecosystem in which the MVNO operates, aligning with the concept in FIG. 1D of the MVNO providing service through multiple MNOs.

The second panel of FIG. 24 focuses on a computer screen 2402 displaying a SIM card management interface. The screen shows “SIM Profile Pre-Allocation” with options for multiple MNOs, corresponding to the pre-loading step described in FIG. 1D. Although not explicitly shown, checkboxes or toggle switches can be included next to “MNO1” 2404, “MNO2” 2406, and “MNO3” 2408, indicating the selection of profiles to be pre-loaded onto the SIM card. This visual representation effectively illustrates the MVNO's ability to choose which network profiles to include on each SIM card, which can be one aspect of the pre-allocation process outlined in FIG. 1D.

The third panel provides a detailed view of a SIM card 2410 with multiple sections highlighted, each representing a different profile slot. These slots are labeled as “MNO1 Profile” 2412, “MNO2 Profile” 2414, and “MNO3 Profile” 2416, visually demonstrating how multiple network profiles can coexist on a single SIM card. Different colors or patterns are used to distinguish between allocated and unallocated profile slots, providing a clear visual representation of the pre-loaded profiles described in FIG. 1D. This detailed view helps to illustrate the technical implementation of the pre-allocation concept, showing how a single SIM card can be prepared to work with multiple networks.

The fourth panel of FIG. 24 presents a split screen showing two scenarios. On the left side, a smartphone 2418 is shown connected to the “MNO1” network, with signal bars and network label visible. On the right side, the same smartphone is depicted connected to the “MNO2” network. This split view effectively demonstrates the end result of the pre-allocation process: the ability to switch between pre-loaded profiles seamlessly. This visual representation aligns with the final step in FIG. 1D, where the pre-loaded SIM card can be provided to a specific client, enabling the MVNO to remotely switch the subscriber's network as needed.

FIG. 25 offers a comprehensive illustration that delves deeper into the SIM profile pre-allocation process in some examples, providing a more detailed view of the concepts introduced in FIG. 1D. This figure effectively visualizes the complex interactions between the MVNO, multiple MNOs, and the SIM card during the pre-allocation and profile management process. At the center of the illustration is an oversized SIM card 2410 with multiple clearly defined sections, each representing a profile for a different MNO. Animated arrows or progress bars are shown loading profiles onto the SIM card, visually representing the pre-loading process described in FIG. 1D.

At the top of FIG. 25, the MVNO system 2400 is depicted with a “Profile Management Server” 2420. Data streams are shown flowing from this server to the SIM card, representing the pre-loading process. This visual element illustrates the MVNO's central role in managing and distributing network profiles, as outlined in FIG. 1D. The bottom of the illustration shows representations of “MNO1” 2422, “MNO2” 2424, and “MNO3” 2426, each with its distinct network infrastructure and iconic buildings or landmarks. These visual representations of the MNOs help to illustrate the multiple partnerships maintained by the MVNO, as described in connection with FIG. 1D.

Dotted lines connect the MVNO system to each MNO, representing partnership agreements. This visual element corresponds to the configuration step in FIG. 1D, where the MVNO can establish relationships with multiple MNOs to provide service. A zoomed-in bubble 2428 shows the encryption process for profile creation, with lock symbols and encrypted data packets. This detail highlights the security aspects of profile creation, which can be one important consideration in the pre-allocation process.

At the bottom of FIG. 25, a small timeline illustrates the sequence: 1) MVNO-MNO agreements, 2) profile creation, 3) SIM pre-loading, 4) distribution to customer, and 5) remote profile switching. This timeline provides a clear, chronological overview of one embodiment of the corresponding process, tying together the various elements illustrated in the figure and relating them back to the steps outlined in FIG. 1D. The timeline effectively demonstrates how the pre-allocation process flows from initial partnerships through to the eventual use of the pre-loaded profiles for network switching.

FIG. 26 presents a detailed box diagram that provides a step-by-step visualization of one example of the SIM profile pre-allocation and usage process, expanding on the concepts introduced in FIG. 1D and illustrated in FIGS. 24 and 25. This figure uses a flowchart format with rectangular boxes for each step, connected by arrows to show the process flow, offering a clear and structured representation of the pre-allocation and usage procedure. The diagram begins with box 2430, labeled “Establish MVNO-MNO partnerships,” corresponding to the initial step in FIG. 1D where the MVNO establishes a configuration to provide service through multiple MNOs.

The next steps in the diagram, represented by boxes 2432 “Create encrypted profiles for each MNO” and 2434 “Pre-load multiple profiles onto SIM”, directly align with the profile creation and pre-loading steps described in FIG. 1D. Box 2434 is larger and highlighted to emphasize its role as the pre-loading step in the process. Box 2436 “Distribute SIM to customer” corresponds to the final step in FIG. 1D, where the pre-loaded SIM can be provided to a specific client.

The diagram continues to illustrate the usage of the pre-loaded profiles. Box 2438 shows the customer using the initial active profile. In box 2440, the MVNO detects a need for a network switch. The MVNO then remotely activates an alternate profile, as shown in box 2442. Box 2444 depicts the customer connecting to the new MNO network. These steps demonstrate how the pre-loaded profiles enable the MVNO to remotely switch the subscriber's network, as described in FIG. 1D. A looping arrow from box 2444 back to box 2440 is included in the diagram. This arrow indicates the potential for multiple switches over time, illustrating the ongoing flexibility provided by the pre-loaded profiles. A callout box 2446 near box 2434 explains: “Multiple profiles pre-loaded, enabling seamless future switches”. This annotation highlights the pre-loading process in enabling flexible network management, which is one aspect of the method described in FIG. 1D.

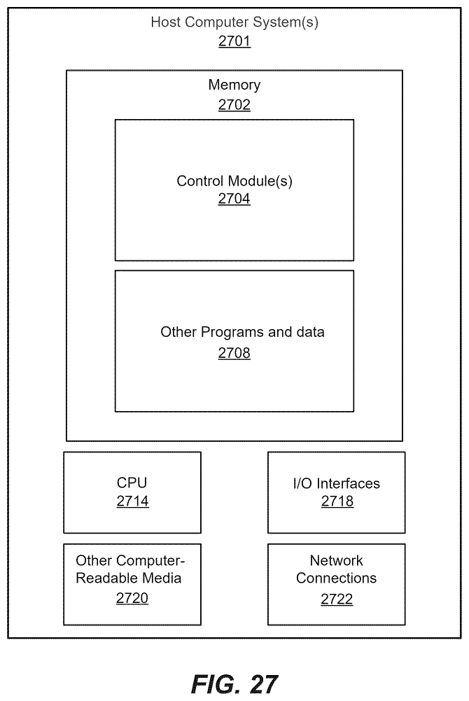

FIG. 27 shows a system diagram that describes an example implementation of a computing system(s) for implementing embodiments described herein. The functionality described herein can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, allowing higher deployment agility and flexibility. However, FIG. 27 illustrates an example of underlying hardware on which such software and functionality may be hosted and/or implemented.

In particular, shown is example host computer system(s) 2701. For example, such computer system(s) 2701 may execute a scripting application, or other software application, as further discussed above, and/or to perform one or more of the other methods described herein. In some embodiments, one or more special-purpose computing systems may be used to implement the functionality described herein. Accordingly, various embodiments described herein may be implemented in software, hardware, firmware, or in some combination thereof. Host computer system(s) 2701 may include memory 2702, one or more central processing units (CPUs) 2714, I/O interfaces 2718, other computer-readable media 2720, and network connections 2722.

Memory 2702 may include one or more various types of non-volatile and/or volatile storage technologies. Examples of memory 2702 may include, but are not limited to, flash memory, hard disk drives, optical drives, solid-state drives, various types of random access memory (RAM), various types of read-only memory (ROM), neural networks, other computer-readable storage media (also referred to as processor-readable storage media), or the like, or any combination thereof. Memory 2702 may be utilized to store information, including computer-readable instructions that are utilized by CPU 2714 to perform actions, including those of embodiments described herein.

Memory 2702 may have stored thereon control module(s) 2704. The control module(s) 2704 may be configured to implement and/or perform some or all of the functions of the systems or components described herein. Memory 2702 may also store other programs and data 2710, which may include rules, databases, application programming interfaces (APIs), software containers, nodes, pods, clusters, node groups, control planes, software defined data centers (SDDCs), microservices, virtualized environments, software platforms, cloud computing service software, network management software, network orchestrator software, network functions (NF), artificial intelligence (AI) or machine learning (ML) programs or models to perform the functionality described herein, user interfaces, operating systems, other network management functions, other NFs, etc.

Network connections 2722 are configured to communicate with other computing devices to facilitate the functionality described herein. In various embodiments, the network connections 2722 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 2718 may include a video interface, other data input or output interfaces, or the like. Other computer-readable media 2720 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
receiving, at a mobile virtual network operator, an indication for a mobile virtual network operator to perform a network switch by switching a home network of a client device of a client of the mobile virtual network operator from a source network infrastructure of a source mobile network operator that is serving the client for the mobile virtual network operator to a target network infrastructure of a target mobile network operator that is serving clients for the mobile virtual network operator; and
performing, by the mobile virtual network operator in response to receiving the indication, the network switch by switching the home network of the client device of the client of the mobile virtual network operator from the source network infrastructure of the source mobile network operator that is serving the client for the mobile virtual network operator to the target network infrastructure of the target mobile network operator that is serving clients for the mobile virtual network operator;
wherein electronic communication between the mobile virtual network operator and the client device of the client configuring the client device for the network switch is performed entirely through cellular connectivity between the mobile virtual network operator and the client device over-the-air.

2. The method of claim 1, wherein the source mobile network operator comprises the mobile virtual network operator functioning as a mobile network operator and the target mobile network operator comprises a third-party mobile network operator.

3. The method of claim 2, wherein performing the network switch comprises the mobile virtual network operator downloading and activating an electronic subscriber identity module profile for the target mobile network operator on the client device while maintaining active connectivity between the client device and the source network infrastructure.

4. The method of claim 2, wherein performing the network switch comprises the mobile virtual network operator switching an active subscriber identity module profile from a first profile specific to the source network infrastructure to a second profile specific to the target network infrastructure.

5. The method of claim 1, wherein the source mobile network operator comprises a third-party mobile network operator and the target mobile network operator comprises the mobile virtual network operator functioning as a mobile network operator.

6. The method of claim 5, wherein the mobile virtual network operator performs the network switch entirely through cellular connectivity between the mobile virtual network operator and the client device over-the-air such that a Wi-Fi connection to the client device is bypassed.

7. The method of claim 5, wherein performing the network switch comprises the mobile virtual network operator provisioning services for the client device on the target network infrastructure before initiating a port out process from the source network infrastructure.

8. The method of claim 1, wherein the source mobile network operator and the target mobile network operator comprise different third-party mobile network operators that are both distinct from the mobile virtual network operator.

9. The method of claim 1, wherein performing the network switch comprises the mobile virtual network operator coordinating timing of a port in process and activation of services on the target network infrastructure at least in part by delaying a port in process until only after confirming successful activation of services on the target network infrastructure.

10. The method of claim 1, wherein performing the network switch comprises the mobile virtual network operator maintaining cellular connectivity with the client device on both the source network infrastructure and the target network infrastructure simultaneously during a portion of the network switch.

11. A non-transitory computer-readable medium that has instructions stored thereon that, when executed by at least one physical computing processor, cause a computing device to perform operations comprising:
receiving, at a mobile virtual network operator, an indication for a mobile virtual network operator to perform a network switch by switching a home network of a client device of a client of the mobile virtual network operator from a source network infrastructure of a source mobile network operator that is serving the client for the mobile virtual network operator to a target network infrastructure of a target mobile network operator that is serving clients for the mobile virtual network operator; and
performing, by the mobile virtual network operator in response to receiving the indication, the network switch by switching the home network of the client device of the client of the mobile virtual network operator from the source network infrastructure of the source mobile network operator that is serving the client for the mobile virtual network operator to the target network infrastructure of the target mobile network operator that is serving clients for the mobile virtual network operator;
wherein electronic communication between the mobile virtual network operator and the client device of the client configuring the client device for the network switch is performed entirely through cellular connectivity between the mobile virtual network operator and the client device over-the-air.

12. The non-transitory computer-readable medium of claim 11, wherein the source mobile network operator comprises the mobile virtual network operator functioning as a mobile network operator and the target mobile network operator comprises a third-party mobile network operator.

13. The non-transitory computer-readable medium of claim 12, wherein performing the network switch comprises the mobile virtual network operator downloading and activating an electronic subscriber identity module profile for the target mobile network operator on the client device while maintaining active connectivity between the client device and the source network infrastructure.

14. The non-transitory computer-readable medium of claim 12, wherein performing the network switch comprises the mobile virtual network operator switching an active subscriber identity module profile from a first profile specific to the source network infrastructure to a second profile specific to the target network infrastructure.

15. The non-transitory computer-readable medium of claim 11, wherein the source mobile network operator comprises a third-party mobile network operator and the target mobile network operator comprises the mobile virtual network operator functioning as a mobile network operator.

16. The non-transitory computer-readable medium of claim 15, wherein the mobile virtual network operator performs the network switch entirely through cellular connectivity between the mobile virtual network operator and the client device over-the-air such that a Wi-Fi connection to the client device is bypassed.

17. The non-transitory computer-readable medium of claim 15, wherein performing the network switch comprises the mobile virtual network operator provisioning services for the client device on the target network infrastructure before initiating a port out process from the source network infrastructure.

18. The non-transitory computer-readable medium of claim 11, wherein the source mobile network operator and the target mobile network operator comprise different third-party mobile network operators that are both distinct from the mobile virtual network operator.

19. A system comprising:
at least one physical computing processor of a computing device; and
a non-transitory computer-readable medium that has instructions stored thereon that, when executed by the at least one physical computing processor, cause the computing device to perform operations comprising:
receiving, at a mobile virtual network operator, an indication for a mobile virtual network operator to perform a network switch by switching a home network of a client device of a client of the mobile virtual network operator from a source network infrastructure of a source mobile network operator that is serving the client for the mobile virtual network operator to a target network infrastructure of a target mobile network operator that is serving clients for the mobile virtual network operator; and
performing, by the mobile virtual network operator in response to receiving the indication, the network switch by switching the home network of the client device of the client of the mobile virtual network operator from the source network infrastructure of the source mobile network operator that is serving the client for the mobile virtual network operator to the target network infrastructure of the target mobile network operator that is serving clients for the mobile virtual network operator;
wherein electronic communication between the mobile virtual network operator and the client device of the client configuring the client device for the network switch is performed entirely through cellular connectivity between the mobile virtual network operator and the client device over-the-air.

20. The system of claim 19, wherein performing the network switch comprises the mobile virtual network operator maintaining cellular connectivity with the client device on both the source network infrastructure and the target network infrastructure simultaneously during a portion of the network switch.
